(19) United States
(12) Patent Application Publication
(10) Pub. No.: US 2026/0080721 A1
(43) Pub. Date: Mar. 19, 2026

(54) METHOD OF PROVIDING AN ALERT TO ANOTHER VEHICLE WITH A MALFUNCTION IN THE VISUAL DISPLAY

(71) Applicant: Volvo Car Corporation, Göteborg (SE)

(72) Inventors: Victor GUSTAFSON, Göteborg (SE); Henrik KLARS, Göteborg (SE); Michael ZACH, Göteborg (SE); Magnus AXELSSON, Göteborg (SE)

(73) Assignee: Volvo Car Corporation, Göteborg (SE)

(21) Appl. No.: 18/888,201

(22) Filed: Sep. 18, 2024

(51) Int. Cl. G07C 5/00; B60Q 11/00; H04W 4/46

(52) U.S. Cl. CPC G07C 5/008; B60Q 11/007; H04W 4/46

(57) ABSTRACT

Embodiments relate to a system and method of providing an alert to another vehicle that has a malfunction, in the visual display. The method includes obtaining, using a sensor, data of a primary vehicle, identifying, based on the obtained data, a malfunction of the primary vehicle, and establishing communication via a communication module, with the primary vehicle. The method further includes transmitting an alert message to the primary vehicle, wherein, the alert message comprises a malfunction information of the malfunction.

### FIELD OF INVENTION

This disclosure relates to the field of vehicle-to-vehicle communication. The disclosure is more particularly related to the method of providing an alert to another vehicle that has a malfunction in the visual display.

### BACKGROUND

The problem with current vehicle systems is that they do not provide a means to alert other vehicles or receive indications from other vehicles with regard to a malfunction in the vehicle's visual display, such as vehicle brake lights or turn signals not working. For example, the driver may physically actuate the turn signal, not knowing that the turn signal display is not working, and the turn signal light does not turn on as the vehicle enters another lane.

Therefore, there is a need for a method of providing an alert to another vehicle that has a malfunction in the visual display.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In an aspect, the present disclosure relates to a system comprising a sensor; a communication module; and a processor storing instructions in a non-transitory memory that, when executed, cause the processor to: obtain, using the sensor, data of a primary vehicle; identify, based on the obtained data, a malfunction of the primary vehicle; establish communication, via the communication module, with the primary vehicle; and transmit, an alert message to the primary vehicle, wherein, the alert message comprises a malfunction information of the malfunction; and wherein the system is configured to be a component of a secondary vehicle.

In one another aspect, the present disclosure relates to a method comprising obtaining, using a sensor, data of a primary vehicle; identifying, based on the obtained data, a malfunction of the primary vehicle; establishing, communication via a communication module, with the primary vehicle; and transmitting, an alert message to the primary vehicle, wherein, the alert message comprises a malfunction information of the malfunction.

In another aspect, the present disclosure relates to a non-transitory computer-readable medium having stored thereon instructions executable by a computer system to perform operations comprising obtaining, data of a primary vehicle; identifying, a malfunction of the primary vehicle based on the data: establishing, communication with the primary vehicle; and transmitting, an alert message to the primary vehicle, wherein, the alert message comprises a malfunction information of the malfunction.

In an aspect, the present disclosure relates to a system comprising a communication module; a diagnostic module; and a processor storing instructions in a non-transitory memory that, when executed, cause the processor to receive, via the communication module, an alert message from a secondary vehicle comprising a malfunction information of a primary vehicle; validate, using the diagnostics module, the malfunction information; confirm, using the diagnostics module, a malfunction of the primary vehicle; and determine a corrective action based on diagnostic information from the diagnostic module; wherein the system is configured to be a component of the primary vehicle.

In one another aspect, the present disclosure relates to a method comprising receiving, via a communication module of a primary vehicle, an alert message from a secondary vehicle, wherein the alert message comprises a malfunction information of the primary vehicle; validating, using a diagnostics module of the primary vehicle, the malfunction information; confirming, using the diagnostics module, a malfunction of the primary vehicle; and determining, a corrective action based on diagnostic information from the diagnostic module.

In another aspect, the present disclosure relates to a non-transitory computer-readable medium having stored thereon instructions executable by a computer system to perform operations comprising receiving, an alert message, wherein the alert message comprises a malfunction information of a primary vehicle; validating, the malfunction information; confirming, a malfunction of the primary vehicle; and determining, a corrective action based on diagnostic information.

### BRIEF DESCRIPTION OF THE FIGURES

These and other aspects of the present invention will now be described in more detail, with reference to the appended drawings showing exemplary embodiments of the present invention, in which:

FIG. 1 illustrates a block diagram of a system for providing and receiving an alert message for a malfunction according to an embodiment.

FIG. 2 illustrates a block diagram of electronic components of the vehicle according to an embodiment.

FIG. 3 illustrates a flow chart describing a method of a secondary vehicle according to an embodiment.

FIG. 4 illustrates steps executed by a system of a secondary vehicle according to an embodiment.

FIG. 5 illustrates a block diagram of the method executed by the non-transitory computer-readable medium according to an embodiment.

FIG. 6 illustrates a block diagram of an example of an environment and system for identification of malfunction of primary vehicle according to an embodiment.

FIG. 7 illustrates a message flow diagram between the secondary vehicle and the primary vehicle according to an embodiment.

FIG. 8 illustrates a flow chart describing a method of a primary vehicle according to an embodiment

FIG. 9 illustrates steps executed by a system of a primary vehicle according to an embodiment.

FIG. 10 illustrates a block diagram of the method executed by the non-transitory computer-readable medium according to an embodiment.

FIG. 11A illustrates an example alert message and content of the message that may be used for communication between the secondary vehicle and the primary vehicle according to an embodiment.

FIG. 11B illustrates an example broadcast message and content of the message that may be used for communication between the primary vehicle and a surrounding vehicle according to an embodiment.

FIG. 11C illustrates an alert message that is displayed on an infotainment system of the primary vehicle which includes a graphic that is generated according to an embodiment.

FIG. 12 illustrates a message flow diagram between the primary vehicle and the surrounding vehicle according to an embodiment.

FIG. 13 illustrates an example block diagram for an Artificial Intelligence and Machine Learning (AI/ML) model used in a system according to an embodiment.

FIG. 14A illustrates a structure of the neural network/machine learning model with a feedback loop according to an embodiment.

FIG. 14B illustrates a structure of the neural network/machine learning model with reinforcement learning according to an embodiment.

FIG. 15A illustrates a block diagram of the cyber security module in view of the system and server according to an embodiment.

FIG. 15B illustrates a block diagram of the cyber security module according to an embodiment.

FIG. 15C illustrates another block diagram of the cyber security module according to an embodiment.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs. The following terms and phrases, unless otherwise indicated, shall be understood to have the following meanings.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items, and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As used herein, two or more elements or modules are “integral” or “integrated” if they operate functionally together. Two or more elements are “non-integral” if each element can operate functionally independently.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

Digital electronic circuitry, or computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Circuit (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome.

As used herein, the term “Data mining” is a process used to turn raw data into useful information. It is the process of analyzing large datasets to uncover hidden patterns, relationships, and insights that can be useful for decision-making and prediction.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses, etc., are examples of vehicles. Further, the vehicle may include electric vehicles (EVs), hybrid electric vehicles (HEVs) such as, without limitations, full hybrid electric vehicles (FHEVs) and mild hybrid electric vehicles (MHEVs), battery electric vehicles (BEVs), and plug-in hybrid electric vehicles (PHEVs).

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication unit” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” or “communication network” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles. Similarly, a Vehicle-to-Grid (V2G) communication may exchange charge information and further transfer charge from the vehicle to the grid.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example communication protocol is a DSRC protocol. The DSRC protocol uses a specific frequency band (e.g., 5.9 GHZ (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle and the second component can be an infrastructure that is enabled by a system of hardware, software, and firmware. In an example, the second component can be another vehicle capable of receiving and transmitting information with the first vehicle.

The term “alert” or “alert signal” refers to a communication to attract attention. An alert may include visual, tactile, audible alert and a combination of these alerts to warn the user of the vehicle. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module”, is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. The driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users' applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers-say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

As used in this application, the terms “component,” “system,” “platform,” “interface,” and/or the like, can refer to and/or can include a computer-related entity or an entity related to an operational machine with one or more specific functionalities. The entities described herein can be cither hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

As used herein the term “monitoring” refers to systematic observation and assessment of a system, process, or environment in real-time or near real-time. It involves the regular collection, analysis, and interpretation of data using various sensors. Monitoring may be continuous or adaptive.

The term “vehicle system” or “computer system” or “system of a vehicle” as used herein refers to the vehicle comprising the system described in the current application. The system may be integrated and is a part of the vehicle, for example, a system executing a method on a processor storing instructions in a non-transitory memory of the computer system of the vehicle. The system may be external, but the instructions or method is executed through the vehicle, for example the method being in a cloud but is accessed and executed by the vehicle. The system may be designed for a specific purpose to carry out a certain function or task, for example, transmitting a specific message to a user device. The designed system comprising instructions may also be using existing systems present on the vehicle, for example, a communication system of the vehicle.

The term “battery” as used herein refers to a battery system in the vehicle, wherein the battery system may be used for starting the vehicle or may be used for operating the vehicle. The battery system may also be used to enable the vehicle to run.

The term “user” as used herein refers to any individual who is a driver or an owner of the vehicle. Broadly, it may encompass any individual having the possession of the vehicle.

The term “malfunction” as used herein refers to a part or a component of the vehicle that is not functioning properly. As an example, a malfunction may occur in at least one or more of a headlight display, a brake light display, a taillight display, a turn indicator display, a lane change by the primary vehicle, a door, a trunk, a tire, and visible emissions from exhaust of the vehicle.

The term “malfunction information” as used herein refers to details on the occurrence of a malfunction in a vehicle. Malfunction information may comprise at least one of a location information of occurrence of the malfunction, a time information of occurrence of the malfunction, image information of the malfunction, video information of the malfunction, a type of the malfunction, a severity of the malfunction, and a repetition of the malfunction.

The term “primary vehicle” as used herein refers to a vehicle with a malfunction, a part or a component of the vehicle that is not functioning properly.

The term “secondary vehicle” as used herein refers to a vehicle that identifies a malfunction of the primary vehicle and transmits malfunction related information to the primary vehicle.

The term “vehicle dynamics” as used herein refers to vehicle motion and vehicle maintaining traction when driving in adverse conditions. Vehicle dynamics may be used to predict and control the motion of the vehicle.

The term “visible emission” as used herein refers to a visible emission from the exhaust of a vehicle. Visible emission may include one or more of smoke, soot, photochemical oxidants, air toxins, and particulate matter coming out of the exhaust system of the vehicle.

The term “nearby vehicle” or “surrounding vehicle” as used herein refers to surrounding vehicles of the user's vehicle and is within reach of at least a communication range of the user's vehicle wherein the communication range is defined as the maximum distance where communication can exist between two antennas, one of which is user's vehicle antenna in a wireless network.

The term “route planning” or “routing” refers to the process of computing the effective method of transportation or transfers through several stops. Basically, route planning is used to ascertain which route is the most cost-effective when moving from one place to another. It also includes route optimization.

The term “route optimization” refers to the process of evaluating the potential combination of options and constraints to produce a route plan that makes the most effective use of the vehicle resources. The route planning process may involve using route optimization technology because of its ability to determine the most effective route plan more extensively and quickly. Route optimization technology employs algorithms and other techniques such as artificial intelligence or machine learning to create the best results.

Business problem: The problem with the current vehicle systems is that they do not provide a means to alert other vehicles/drivers or receive indications from other vehicles with regard to a malfunction in a vehicle, such as vehicle brake lights or turn signals not working. For example, the driver may physically actuate the turn signal, not knowing that the turn signal display is not working, and the turn signal light does not turn on as the vehicle enters another lane. This can cause accidents. Thus, it would be useful if the driver of the vehicle was alerted by other vehicles that its turn signal did not provide a visual indication, or the vehicle is experiencing another malfunction.

Technical problem: A vehicle may have a malfunctioning component and the vehicle may not have detected that there is a malfunction in the vehicle. Also, the driver of the vehicle may not be aware of the problem with the vehicle. There is no mechanism for the vehicle or the driver of the vehicle to know about the problem which can cause mishaps. This may further lead to other problems in the vehicle, such as the vehicle may stop functioning.

Business solution: A vehicle with a malfunction, such as a turn signal not working, may be notified by another vehicle that it changed its lane, however no visual indication was provided, as the turn signal did not turn on. The vehicle with the malfunction may be referred to as a primary vehicle and the vehicle notifying the primary vehicle of its malfunction may be referred to as a secondary vehicle. The primary vehicle on receiving the communication may diagnose the problem and take corrective action accordingly. The primary vehicle may also communicate to nearby vehicles that it has a malfunction, thus resulting in safer driving until the problem is fixed.

Technical solution: In an aspect, the system of the secondary vehicle detects a primary vehicle entering into the lane without any visual indication. The system notifies the primary vehicle that no visual indication is provided via V2X communication. The primary vehicle determines the problem based on the notification and until the problem is fixed the primary vehicle can provide an alternate means to communicate information on the malfunction to the surrounding vehicles, such as a broadcast message. The primary vehicle can further establish communication with a service station for repair of the malfunctioning component.

In an aspect, the present disclosure relates to a system comprising a sensor; a communication module; and a processor storing instructions in a non-transitory memory that, when executed, cause the processor to: obtain, using the sensor, data of a primary vehicle; identify, based on the obtained data, a malfunction of the primary vehicle; establish communication, via the communication module, with the primary vehicle; and transmit, an alert message to the primary vehicle, wherein, the alert message comprises a malfunction information of the malfunction; and wherein the system is configured to be a component of a secondary vehicle.

In another aspect, the present disclosure relates to a method comprising obtaining, using a sensor, data of a primary vehicle; identifying, based on the obtained data, a malfunction of the primary vehicle: establishing, communication, via a communication module, with the primary vehicle; and transmitting, an alert message to the primary vehicle, wherein, the alert message comprises a malfunction information of the malfunction.

In another aspect, the present disclosure relates to a non-transitory computer-readable medium having stored thereon instructions executable by a computer system to perform operations comprising obtaining, data of a primary vehicle: identifying, a malfunction of the primary vehicle based on the data; establishing, communication with the primary vehicle; and transmitting, an alert message to the primary vehicle, wherein, the alert message comprises a malfunction information of the malfunction.

In an aspect, the present disclosure relates to a system comprising a communication module; a diagnostic module; and a processor storing instructions in a non-transitory memory that, when executed, cause the processor to receive, via the communication module, an alert message from a secondary vehicle comprising a malfunction information of a primary vehicle; validate, using the diagnostics module, the malfunction information; confirm, using the diagnostics module, a malfunction of the primary vehicle; and determine a corrective action based on diagnostic information from the diagnostic module; wherein the system is configured to be a component of the primary vehicle.

In one another aspect, the present disclosure relates to a method comprising receiving, via a communication module of a primary vehicle, an alert message from a secondary vehicle, wherein the alert message comprises a malfunction information of the primary vehicle; validating, using a diagnostics module of the primary vehicle, the malfunction information; confirming, using the diagnostics module, a malfunction of the primary vehicle; and determining, a corrective action based on diagnostic information from the diagnostic module.

In another aspect, the present disclosure relates to a non-transitory computer-readable medium having stored thereon instructions executable by a computer system to perform operations comprising receiving, an alert message, wherein the alert message comprises a malfunction information of a primary vehicle; validating, the malfunction information; confirming, a malfunction of the primary vehicle; and determining, a corrective action based on diagnostic information.

Technical Result: The method of providing an alert to a vehicle that has a malfunction ensures that the vehicle and the user of the vehicle are made aware of the malfunction. Accordingly, the vehicle receiving the alert message can take corrective action based on the received alert message.

How Technical Solution is a Technological Advancement: The system is designed to address the challenge of identifying a malfunction in a primary vehicle and transmitting an alert message to the primary vehicle. The primary vehicle may validate the malfunction information and take corrective action for the malfunction. The system leverages advanced technologies, including machine learning, bidirectional communication, identification of a malfunction, validation and confirmation of the malfunction to take corrective action for the malfunction.

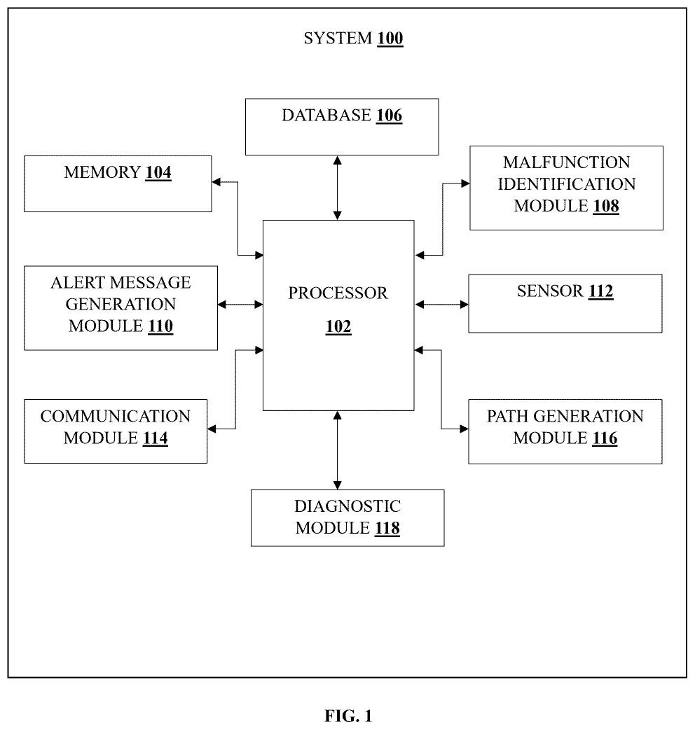

Technical Details Specific to the Technical Solution: FIG. 1 illustrates a block diagram of a system for providing and receiving an alert message for a malfunction according to an embodiment.

The system 100 comprises processor 102, memory 104, database 106, malfunction identification module 108, alert message generation module 110, sensor 112, communication module 114, and path generation module 116. The secondary vehicle may continuously obtain data of a primary vehicle, identify a malfunction of the primary vehicle, establish communication with the primary vehicle, and transmit malfunction information to the primary vehicle. The primary vehicle may accordingly take corrective action based on the information received from the secondary vehicle. System 100 can be deployed in the primary vehicle or the secondary vehicle. The system of both the primary vehicle and the secondary vehicle may be located on one vehicle.

Referring to FIG. 1, processor 102 may be a high-performance, multi-core CPU or system-on-chip (SoC) solution to process vast amounts of data. In some embodiments, processor 102 processes data from database 106, sensor 112, and other inputs to make real-time decisions related to identification of a malfunction and accordingly taking corrective action. Processor 102 may comprise Graphics Processing Units (GPUs). GPUs are utilized for their ability to accelerate tasks like data processing. The processor may depend on factors such as processing requirements and power consumption. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instructions. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze input data, determine conditions associated with the primary and secondary vehicles, interpret the environment, and help in decision making. In an embodiment, the processor may be a neuromorphic processor, inspired by the human brain, which offers a unique approach to handling AI tasks. Processor 102 interacts and exchanges data with one or more of the other components or modules of the system, for example, memory 104, database 106, malfunction identification module 108, alert message generation module 110, sensor 112, communication module 114, path generation module 116. The processor computes and processes the malfunction information, and controls and coordinates the communication module, the malfunction identification module, the alert message generation module, the path generation module, and the memory. The processor may establish a dynamic alert message according to the malfunction information associated with the primary vehicle and display the alert message via the display unit in real time.

Referring to FIG. 1, memory 104 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a cloud-based memory. In another embodiment, the memory may be a local memory. In another embodiment, it may be a combination of local and cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

Referring to FIG. 1, in some embodiments, database 106 may store data associated with the malfunction, the alert message, the malfunction information, malfunction identification module 108, alert message generation module 110, sensor 112, and path generation module 116. In some embodiments, database 106 may be locally present in system 100 or may be present in a cloud server. Processor 102 may fetch the data from the database to determine malfunction information of the occurrence of malfunction in the primary vehicle. Processor 102 may fetch the data from the database to confirm the malfunction and take corrective action.

The malfunction identification module 108 may confirm a malfunction through image or video processing. Using combinations of these information streams, a sophisticated software algorithm may make predictions and suggest a malfunction, a severity, and a possible suggestion to address the malfunction. Using machine learning and video processing, a malfunction may be determined in the primary vehicle. The malfunction identification module may use data received from the camera and/or the sensors to detect a malfunction. The malfunction identification module 108 may transmit a notification to communication module 114 to communicate malfunction information to the vehicle. In some examples, a fine may be sent to the driver of the vehicle. The malfunction identification module 108 may geotag the location, date, time, vehicle information, and may update GPS metadata indicating a description of the malfunction. According to an embodiment, the malfunction identification module 108, based on vehicle dynamics input, includes a communication module positioned to receive and send malfunction data in vehicle mobility data format. The malfunction identification module 108 may include vision-based vehicle detection. Vision sensors may be coupled with methods such as deep learning methods with Region-based Convolutional Neural Networks (R-CNNs) or Fast R-CNNs. In an embodiment, a radar system is used for object-detection which uses radio waves to determine the range, direction, or speed of objects. It may be configured to detect vehicles. The radar antenna transmits pulses of radio waves which bounce off any object in their path. The object returns a small part of the wave's energy to the receiver antenna which is usually located at the same site as the transmitter. In an embodiment, the sensor that detects the nearby vehicles comprises at least one of an infrared sensor, an ultrasonic sensor, a radar sensor, a passive acoustic detector array, a piezoelectric sensor, a photoelectric sensor and a camera. In an embodiment, the malfunction identification module may comprise a machine learning algorithm. In an embodiment, the malfunction identification module may comprise an artificial intelligence engine performing video analytics of real-time videos, and image processing of images.

The alert message generation module 110 may generate an alert message when a malfunction is identified from the sensor data obtained from the primary vehicle. The alert message generation module may further control information displayed on an infotainment system, a rear display, and a front display. The alert message generation module may be designed to display information to different intended users, depending on the positioning of the user's vehicle and the other vehicles. In an embodiment, the display data may include stored display patterns, sequences, colors, text, animation, or other data to be displayed on the front and/or rear display. The display data may also include algorithms for generating further content and controlling how it is displayed. The generated content, for example, may be personalized based on information received from the system, any third-party system, the vehicle, and the computing devices.

The sensor(s) 112 may include a variety of sensors for monitoring the operation and/or environment in which a vehicle may be operating. The sensor(s) may include, but are not limited to, tire pressure sensors, tire blowout sensors, cameras, water sensors, collision sensors, traction control sensors, speed sensors, brake sensors, scales, radio frequency identification receivers, a vehicle computer, etc. The vehicle may be a car, van, etc. The vehicle may include an electronic navigation system including a global positioning system (GPS) receiver. The secondary vehicle may be traveling on a roadway and the GPS receiver may track the position of the primary vehicle as it moves along the roadway. The secondary vehicle may include a variety of sensors for monitoring components of the primary vehicle. The sensors may be connected (e.g., using CAN bus, etc.) to an onboard computer that uses inputs received from the sensors to identify a malfunction of the primary vehicle, and the communication module transmits an alert message to the primary vehicle. The GPS receiver may collect location information as the vehicles travel along a roadway. The GPS receiver may output location data to the malfunction identification module 108. In an example, a first image may be obtained of the primary vehicle from the sensor data. For example, an image may be received from a camera included in the sensor(s). A second image of an area around the vehicle may be obtained from the sensor(s). For example, an image of the roadway behind the truck may be obtained from the camera included in the sensor(s). For example, the second image may be analyzed to determine that the taillight of the primary vehicle is malfunctioning. In an example, a measurement may be obtained between the primary vehicle and the sensor(s) from the sensor data. For example, a distance measurement may be obtained between a tire of the vehicle and a depth sensor included in the sensor(s). The data may be obtained directly from sensor(s), camera and/or from the onboard computer of the secondary vehicle. The data may include images, measurements, and other data that may be used to determine a malfunction of the primary vehicle. The system may collect geolocation data from a GPS receiver in the secondary vehicle upon determining that the primary vehicle has a malfunction. The geolocation data may be used to identify the location of the primary vehicle. The identified primary vehicle may be tagged with geolocation data. The communication module may transmit, to at least one of a GPS display, driver notification display, and infotainment display of the primary vehicle, an alert message to the driver of the primary vehicle.

Referring to FIG. 1, sensors 112 may comprise various sensors such as a temperature sensor, ultrasonic sensors, LIDAR sensors, radar sensors, camera-based sensors, Infrared (IR) sensors, radio frequency identification (RFID) sensors, etc. Sensors, for example, including cameras, LIDARs, radars, and ultrasonic sensors enable autonomous vehicles to detect and recognize objects, obstacles, and pedestrians on the road to enable navigation of the autonomous vehicles. In some embodiments, communication module 114 facilitates communication between different modules within system 100, communication between the vehicle and other devices, other vehicles, and other infrastructure components. In an embodiment, the sensors 112 may comprise a laser radar, an infrared-ray radar, a millimeter-wave radar, an image identification device, a short-range wireless device, or an optical communication device capable of detecting the location and angle of each primary vehicle. In an embodiment, the sensors may comprise a plurality of multi-modal sensory arrays, that may include a plurality of microphones for obtaining audio information, a plurality of video cameras for obtaining video information, and one or more movement-related sensors for obtaining vehicle movement-related information. The system may utilize components with range map capability such as LIDAR or a Stereo Vision system to determine the relevant dimensions of a primary vehicle, categorize the measurements into relevant categories, and transmit the relevant information in relation to global coordinates. This feature also uses geometric data captured from a sensor such as LIDAR or Stereo Vision with the capability to measure vehicle attributes such as size. In an embodiment, the driving environment of the primary vehicle may be obtained by acquiring images around the vehicle by at least one image acquisition apparatus (for example, a camera, etc.) disposed around the secondary vehicle. The driving environment may include multiple types of target objects that can be observed around the primary vehicle. To ensure the continuity of the malfunction detection, continuous multiple image frames around the primary vehicle can be acquired by the image acquisition apparatus, for example, the driving environment of the vehicle is detected by acquiring a video, where the continuous multiple image frames may refer to each image frame in a temporal continuous video or may also refer to multiple image frames having the malfunction, where the two continuous image frames are discontinuous in time.

Referring to FIG. 1, communication module 114 is coupled to processor 102. Communication module 114 may communicate with external devices such as other vehicles and may transmit to the processor. Processor 102 may generate malfunction information based on the data acquired from the other vehicle and the communication module may transmit the malfunction information to the other vehicle. The communication module 114 enables in-vehicle communication, communication with other vehicles, infrastructure communication, grid communication, etc., using Vehicle to network (V2N), Vehicle to infrastructure (V2I), Vehicle to vehicle (V2V), Vehicle to cloud (V2C), Vehicle to pedestrian (V2P), Vehicle to device (V2D), Vehicle to grid (V2G) communication systems. Thus, communications with the vehicle systems may be through one or more interfaces, including but not limited to Universal Serial Bus (USB), Media Oriented System Transport (MOST) bus, Control Area Network (CAN) bus, Ethernet, Universal Asynchronous Receiver-Transmitter (UART) or Serial Peripheral Interface (SPI). The vehicle uses, for example, a message protocol, a message that goes to the other vehicles via a broadcast. The communication module 114 may comprise hardware such as an audio or video recorder and software such as methods, programs and algorithms that would enable recording the data from another vehicle. In an embodiment, the communication module 114 may provide content, information, data, and/or media associated with the primary vehicle to the primary vehicle and one or more devices such as mobile phones, a device that is located or associated with the vehicle, a wearable device, wearable computers, and the like.

The alert message may further be transmitted or received over a communications network using a transmission medium via the communication module utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet mobile telephone networks (e.g., cellular networks), Plain Old Telephone (POTS) networks), and wireless data networks (e.g., Institute of Electrical and. Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the communication module may include one or more physical jacks (e.g., Ethernet, coaxial, or phone jacks) or one or more antennas to connect to the communications network. In an example, the communication module may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the vehicle, and includes digital or analog communications signals or other intangible medium to facilitate communication of such software. The communication module may comprise a hardware component comprising a microcontroller, a transceiver, a power management integrated circuit, an Internet of Things device capable of transmitting one of an analog and a digital signal over one of a telephone, a communication either wired or wirelessly.

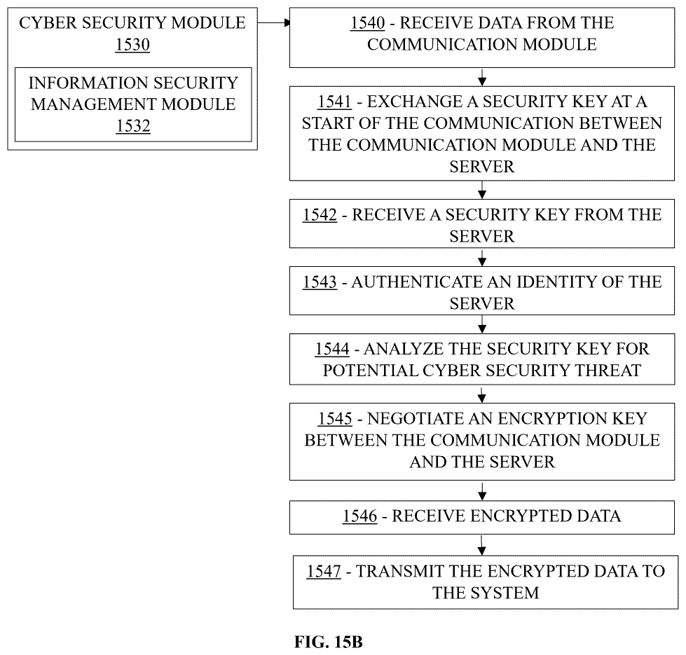

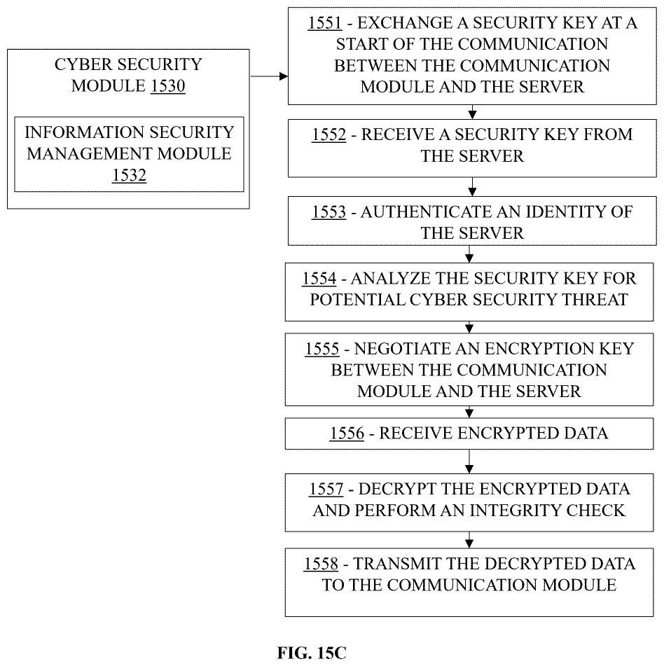

In an embodiment, communication module 114 may comprise a cyber security module 1530 (shown in FIG. 15A). In some embodiments, communication module 114 may communicate with cyber security module 1530 to perform secure communication with nearby devices and external networks. In one aspect, a secure communication management (SCMT) computer device is provided for providing secure communication. The SCMT computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment, and transmit the converted first data message to the vehicle system using a first communication protocol associated with the vehicle system. According to an embodiment, secure authentication for data transmissions comprises, provisioning a hardware-based security engine (HSE) located in communications system, said HSE having been manufactured in a secure environment and certified in said secure environment as part of an approved network, performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using a hardware-based security engine including identifying a user device (UD) that incorporates credentials embodied in hardware using a hardware-based module provisioned with one or more security aspects for securing the system, wherein security aspects comprising said hardware-based module communicating with a user of said user device and said HSE.

The path generation module 116 may comprise hardware such as sensors, circuits, processors, and software such as methods, programs, and algorithms, which would enable the computation and generation of a path from a current location to a second location while considering the surrounding dynamic environment. In an embodiment, the path generation module 116 computes a path based on certain speed and location of the nearby vehicles, and the communication module communicates a request speed and/or course to the nearby vehicles so that the nearby vehicles can adjust their current speed to the requested speed and/or current course to the requested course to enable the vehicle with the malfunction to navigate through the traffic to a destination point. Path generation module 116 may select a region of a road of travel ahead of the vehicle based on sensor data indicative of the road of travel ahead of the user's vehicle; based on a speed and the location of the user's vehicle and based on the speed and location of the nearby vehicles, the module determines a braking profile having a plurality of phases. The path generation module 116 may determine a path for the primary vehicle where the use of the malfunctioning component may be minimal.

The diagnostic module 118 may comprise hardware such as sensors, circuits, processors, and software such as methods, programs, and algorithms, which would enable the computation and generation of diagnostic information of the vehicle. In an embodiment, the diagnostic module 118 may include a sensor for detecting a fault trigger and a vehicle display configured to receive a user input. The diagnostic module 118 may include a communications device configured to communicate with a service center and a processor in communication with the sensor, the vehicle display, and the communications device. The processor may be configured to receive the fault trigger and determine the close or preferred service center. The processor may communicate the fault trigger to the service center and receive an analysis report and an appointment request from the service center. The processor may output the analysis report and appointment request to the vehicle display.

It would be appreciated by a person ordinarily skilled in the art that system 100 is not restricted to only the components shown in FIG. 1 and may include various other components.

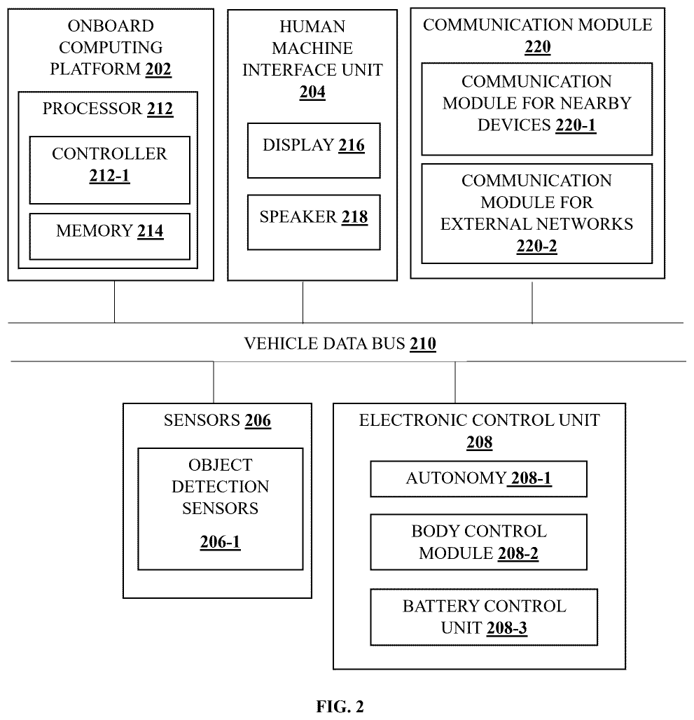

FIG. 2 illustrates a block diagram of various electronic components of the vehicle according to an embodiment.

Referring to FIG. 2 the vehicle comprising various electronic components, such as, onboard computing platform 202, human-machine interface (HMI) unit 204, communication module 220, sensors 206, electronic control units (ECUs) 208, and vehicle data bus 210 are shown. Onboard computing platform 202 comprises processor 212 (also referred to as a microcontroller unit or a controller) and memory 214. In the illustrated example, processor 212 of the onboard computing platform is structured to comprise a controller 212-1. In other examples, controller 212-1 is incorporated into another ECU with its own processor and memory. The processor 212 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 214 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives), etc. In some examples, memory 214 comprises multiple kinds of memory, particularly volatile memory, and non-volatile memory. Memory 214 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 214, the computer-readable medium, and/or within processor 212 during execution of the instructions.

HMI unit 204 provides an interface between the vehicle and a user. HMI unit 204 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, display 216 (e.g., a heads-up display, a center console display such as a liquid crystal display (LCD), an organic light emitting diode (OLED) display, a flat panel display, a solid state display, etc.), and/or speaker 218. For example, the display, the speaker, and/or other input and output device(s) of the HMI unit 204 are operable to emit an alert, such as an alert to request manual takeover to an operator (e.g., a driver) of the vehicle. Further, the HMI unit of the illustrated example comprises hardware (e.g., a processor or controller, memory, storage, etc.) and software (e.g., an operating system, etc.) for an infotainment system that is presented via display 216.

Sensors 206 are arranged in and/or around the vehicle to monitor the interior regions of the vehicle and/or an environment in which the vehicle is driving. One or more of the sensors may be mounted to measure various parameters around an exterior of the vehicle. Additionally, or alternatively, one or more of sensors may be mounted inside a cabin of the vehicle or in a body of the vehicle (e.g., an engine compartment, wheel wells, etc.) to measure properties of the vehicle and/or interior sensing of the vehicle. For example, sensors 206 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. According to an embodiment of the system, the one or more sensors associated with the vehicle comprises camera-based sensors or a camera coupled with a computer vision system.

Referring to FIG. 2, ECUs 208 monitor and control the subsystems of the vehicle. For example, ECUs 208 are discrete sets of electronics that comprise their own circuit(s) (e.g., integrated circuits, microprocessors, memory, storage, etc.) and firmware, sensors, actuators, and/or mounting hardware. ECUs 208 communicate and exchange information via vehicle data bus 210. Additionally, the ECUs may communicate properties (e.g., status of the ECUs, sensor readings, control state, errors, and diagnostic codes, etc.) and receive requests from each other. For example, the vehicle may have many ECUs that are positioned in various locations around the vehicle and are communicatively coupled by the vehicle data bus.

In the illustrated example, ECUs 208 comprise autonomy unit 208-1, body control module 208-2, and battery control unit 208-3. For example, autonomy unit 208-1 is operable to perform autonomous and/or semi-autonomous driving maneuvers (e.g., defensive driving maneuvers) of the vehicle based upon, at least in part, instructions received from controller 212-1 and/or data collected by sensors 206 (e.g., object detection sensors 206-1). Further, body control module 208-2 controls one or more subsystems throughout the vehicle, such as power windows, power locks, an immobilizer system, power mirrors, etc. For example, body control module 208-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc. For example, the battery control unit 208-3 unit is operable to control the bi-directional on-board charger for charging and discharging the vehicle battery based on signals from the processor 212.

Referring to FIG. 2, vehicle data bus 210 communicatively couples communication module 220, onboard computing platform 202, HMI unit 204, sensors 206, and ECUs 208. In some examples, vehicle data bus 210 comprises one or more data buses. Vehicle data bus 210 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

In some embodiments, the vehicle comprises a battery module. The battery module may comprise the battery control unit 208-3 operatively coupled to a vehicle battery and an on-board charger. The battery control unit 208-3 may be operable to control the operation of the on-board charger for charging and discharging the vehicle battery.

Referring to FIG. 2, communication module 220 may comprise a near field communication module or a communication module for nearby devices 220-1 and far field communication module or communication module for external networks 220-2. Communication module for nearby devices 220-1 is operable to communicate with other nearby communication devices. In an example, communication module 220 comprises a dedicated short-range communication (DSRC) module.

A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

V2V communication is typically based on wireless communication protocols such as Dedicated Short-Range Communications (DSRC) or Cellular Vehicle-to-Everything (C-V2X) technology. With V2V communication, vehicles can receive information about potential hazards, such as accidents or road closures, and adjust their behavior accordingly. V2V communication can also be used to support advanced driver assistance systems (ADAS) and automated driving technologies, such as platooning, where a group of vehicles travel closely together using V2V communication to coordinate their movements.

DSRC systems may be installed on vehicles and along roadsides on infrastructure. DSRC systems incorporating infrastructure information are known as “roadside” systems. DSRC may be combined with other technologies, such as Global Position System (GPS), Visual Light Communications (VLC), Cellular Communications, and short range radar, facilitating the vehicles communicating their position, speed, heading, relative position to other objects and to exchange information with other vehicles or external computer systems. DSRC systems can be integrated with other systems such as mobile phones.

Currently, the DSRC network is identified under the DSRC abbreviation or name. However, other names are sometimes used, usually related to a Connected Vehicle program or the like. Most of these systems are either pure DSRC or a variation of the IEEE 802.11 wireless standard. However, besides the pure DSRC system it is also meant to cover dedicated wireless communication systems between cars and roadside infrastructure systems, which are integrated with GPS and are based on an IEEE 802.11 protocol for wireless local area networks (such as 802.11p, etc.).

Additionally, or alternatively, communication module for external networks 220-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V2X communication are being developed by the 3^{rd} Generation Partnership Project. Further, communication module for external networks 220-2 is operable to communicate with external networks. For example, communication module for external networks 220-2 comprises hardware (e.g., processors, memory, storage, antenna, etc.) and software to control wired or wireless network interfaces. In the illustrated example, the communication module 220 comprises one or more communication controllers for cellular networks (e.g., Global System for Mobile Communications (GSM), Universal Mobile Telecommunications System (UMTS), Long Term Evolution (LTE), Code Division Multiple Access (CDMA)), fifth generation 5G networks, Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 220-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising a vehicle gateway system comprising a microcontroller, a transceiver, a power management integrated circuit, an Internet of Things device capable of transmitting one of an analog and a digital signal over one of a telephone, a communication, either wired or wirelessly.

Autonomy unit 208-1 of the illustrated example is operable to perform autonomous and/or semi-autonomous driving maneuvers, such as defensive driving maneuvers, for the vehicle. For example, autonomy unit 208-1 performs the autonomous and/or semi-autonomous driving maneuvers based on data collected by sensors 206. In some examples, autonomy unit 208-1 is operable to operate a fully autonomous system, a park-assist system, an advanced driver-assistance system (ADAS), and/or other autonomous system(s) for the vehicle.

An ADAS is configured to assist a driver in safely operating the vehicle. For example, the ADAS is configured to perform adaptive cruise control, collision avoidance, lane-assist (e.g., lane centering), blind-spot detection, rear-collision warning(s), lane departure warnings and/or any other function(s) that assist the driver in operating the vehicle. To perform the driver-assistance features, the ADAS monitors objects (e.g., vehicles, pedestrians, traffic signals, etc.) and develops situational awareness around the vehicle. For example, the ADAS utilizes data collected by the sensors 206, the communication module 220-1 (e.g., from other vehicles, from roadside units, etc.), the communication module 220-2 from a remote server, and/or other sources to monitor the nearby objects and develop situational awareness.

Further, in the illustrated example, controller (or control module) 212-1 is operable to monitor an ambient environment of the vehicle. For example, the controller may detect overheating of the vehicle battery, and take corrective action, such as stopping the battery charging or discharging, in case of overheating, for a certain time period. For example, to enable autonomy unit 208-1 to perform autonomous and/or semi-autonomous driving maneuvers, the controller collects data that is collected by sensors 206 of the vehicle. In some examples, the controller collects location-based data via communication module 220-1 and/or another module (e.g., a GPS receiver) to facilitate the autonomy unit in performing autonomous and/or semi-autonomous driving maneuvers. Additionally, the controller collects data from (i) adjacent vehicle(s) via communication module 220-1 and V2V communication and/or (ii) roadside unit(s) via communication module 220-1 and V2I communication to further facilitate autonomy unit 208-1 in performing autonomous and/or semi-autonomous driving maneuvers.

In operation, according to an embodiment, the communication module 220-1 performs V2V communication with an adjacent vehicle. For example, the communication module 220-1 collects data from the adjacent vehicle that identifies (i) whether the adjacent vehicle includes an autonomous and/or semi-autonomous system (e.g., ADAS), (ii) whether the autonomous and/or semi-autonomous system is active, (iii) whether a manual takeover request of the autonomous and/or semi-autonomous system has been issued, (iv) lane-detection information of the adjacent vehicle, (v) a speed and/or acceleration of the adjacent vehicle, (vi) a (relative) position of the adjacent vehicle, (vii) a direction-of-travel of the adjacent vehicle, (viii) a steering angle rate-of-change of the adjacent vehicle, (ix) dimensions of the adjacent vehicle, (x) whether the adjacent vehicle is utilizing stability control system(s) (e.g., anti-lock braking, traction control, electronic stability control, etc.), and/or any other information that facilitates the controller 212-1 in monitoring the adjacent vehicle.

Based at least partially on the data that the communication module 220-1 collects from the adjacent vehicle via V2V communication, the controller 212-1 can determine a collision probability for the adjacent vehicle. For example, the controller 212-1 determines a collision probability for the adjacent vehicle in response to identifying a manual takeover request within the data collected by the communication module 220-1 from the adjacent vehicle. Additionally, or alternatively, the controller 212-1 determines a collision probability for the adjacent vehicle in response to identifying a discrepancy between (i) lane-marker locations determined by the controller 212-1 of the vehicle based on the sensors 206 and (ii) lane-marker location determined by the adjacent vehicle. Further, in some examples, the controller 212-1 determines the collision probability for the adjacent vehicle based on data collected from other sources, such as the sensors 206, e.g., range detector sensors and/or other sensor(s) of the vehicle, roadside unit(s) in communication with the communication module 220-1 via V2I communication, and/or remote server(s) in communication with the communication module 220-1. For example, the controller 212-1 determines the collision probability for the adjacent vehicle upon determining, based on data collected by the sensors of the vehicle and the adjacent vehicle, that the adjacent vehicle has not detected a nearby object.

In some examples, the controller 212-1 determines the collision probability based on a takeover time for the adjacent vehicle and/or a time-to-collision of the adjacent vehicle. For example, the takeover time corresponds with a duration of time between (1) the adjacent vehicle emitting a request for a manual takeover to be performed and (2) an operator of the adjacent vehicle manually taking over control of the adjacent vehicle. The controller 212-1 is configured to determine the takeover time of the adjacent vehicle based on measured characteristics of the adjacent vehicle (e.g., velocity, acceleration, dimensions, etc.), the operator of the adjacent vehicle (e.g., a measured reaction time, etc.), and/or an environment of the adjacent vehicle (e.g., road conditions, weather conditions, etc.). Further, the time-to-collision corresponds with the time it would take for the adjacent vehicle to collide with another vehicle (e.g., a third vehicle) and/or object (e.g., a guardrail, a highway lane divider, etc.) if the current conditions were maintained.

Additionally, or alternatively, the controller 212-1 is configured to determine the time-to-collision of the adjacent vehicle based on a velocity, an acceleration, a direction-of-travel, a distance to the object, a required steering angle to avoid the object, a steering angle rate-of-change, and/or other measured characteristics of the adjacent vehicle that the communication module 220-1 collects from the adjacent vehicle via V2V communication. Further, the controller 212-1 is configured to determine a collision probability for the vehicle based on the collision probability of the adjacent vehicle.

Upon determining the collision probability of the adjacent vehicle and determining that the collision probability is not as per threshold, the autonomy unit 408-1 autonomously performs (e.g., for the ADAS) a defensive driving maneuver to prevent the vehicle from being involved in a collision caused by the adjacent vehicle. For example, the autonomous defensive driving maneuver includes deceleration, emergency braking, changing of lanes, changing of position within a current lane of travel, etc. In some examples, the autonomy unit 208-1 is configured to initiate the defensive driving maneuver before the takeover time of the adjacent vehicle has been completed. That is, the controller 212-1 is configured to cause the autonomy unit 208-1 to perform the defensive driving maneuver before the operator of the adjacent vehicle manually takes over control of the adjacent vehicle. Further, in some examples, the controller 212-1 emits an audio, visual, haptic, and/or other alert (e.g., via an HMI unit 204) for the operator of the vehicle to request manual takeover in response to determining that the collision probability is less than the first threshold and greater than the second threshold. By emitting such an alert, the controller 212-1 enables the operator of the vehicle to safely take control of the vehicle before the adjacent vehicle is potentially involved in a collision. Additionally, or alternatively, the controller 212-1 is configured to perform other defensive measures (e.g., prefilling brake fluid lines) in response to determining that the collision probability is greater than a threshold (e.g., the second threshold, a third threshold).

In an embodiment, a connection is established between a vehicle and a nearby vehicle, which is a surrounding car. A nearby vehicle is detected by the vehicle control system. The nearby vehicle is detected by exchanging handshaking signals. The handshaking is the automated process for negotiation of setting up a communication channel between entities. The processor sends a start signal through the communication channel in order to detect a nearby vehicle. If there is a nearby vehicle, the processor may receive an acknowledgement signal from the nearby vehicle. Upon receiving the acknowledgement signal, the processor establishes a secured connection with the nearby vehicle. The processor may receive a signal at the communication module from the nearby vehicle. The processor may further automatically determine the origin of the signal. The processor communicatively connects the communication module to the nearby vehicle. Then the processor is configured to send and/or receive a message to and/or from the nearby vehicle. The signals received by the communication module may be analyzed to identify the origin of the signal to determine a location of the nearby vehicle.

In an embodiment, the system is enabled for bidirectional communication. The system sends a signal and then receives a signal/communication. In an embodiment, the communication could be a permission for access to control the other vehicle. In another embodiment, the communication could be an incremental control communication, for example, an initial control of the speed up to 10 miles per hour, then further additional 10 miles per hour, and so on.

As a first step of the method according to the disclosure, a data link between the vehicle and nearby vehicle or any other external device is set up in order to permit data to be exchanged between the vehicle and the nearby vehicle or any other external device in the form of a bidirectional communication. This can take place, for example, via a radio link or a data cable. It is therefore possible for the nearby vehicle or any other external device to receive data from the vehicle or for the vehicle to request data from the nearby vehicle or any other external device.

In an embodiment, bidirectional communication comprises the means for data acquisition and are designed to exchange data bidirectionally with one another. In addition, at least the vehicle comprises the logical means for gathering the data and arranging it to a certain protocol based on the receiving entity's protocol.

Initially, a data link for bidirectional communication is set up. The vehicle and the nearby vehicle or any other external device can communicate with one another via this data link and therefore request or exchange data, wherein the data link can be implemented, for example, as a cable link or radio link.

Bidirectional communication has various advantages as described herein. In various embodiments, data is communicated and transferred at a suitable interval, including, for example, 200 millisecond (ms) intervals, 100 ms intervals, 50 ms intervals, 20 ms intervals, 10 ms intervals, or even more frequent and/or in real-time or near real-time, in order to allow a vehicle to respond to, or otherwise react to, data. Bidirectional IR communication may be used to facilitate the data exchange.

The apparatus for the vehicle according to the embodiment that performs bidirectional communication may be by means of a personal area network (PAN) modem. Therefore, a user can have access to an external device using the vehicle information terminal, and can then store, move, and delete the user's desired data.

The communication module enables in-vehicle communication, communication with other vehicles, infrastructure communication, grid communication, etc., using Vehicle to network (V2N), Vehicle to infrastructure (V2I), Vehicle to vehicle (V2V), Vehicle to cloud (V2C), Vehicle to pedestrian (V2P), Vehicle to device (V2D), Vehicle to grid (V2G) communication systems. The vehicle uses, for example, a message protocol, a message that goes to the other vehicles via a broadcast.

According to an embodiment, the communication module 220 supports a communication protocol, wherein the communication protocol comprises at least one of a Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Diagnostics Over Internet Protocol (DoIP), On-Board Diagnostics (OBD) protocol, and a predefined protocol standard. In an embodiment, communication module 220 may comprise a cyber security module 1530 (shown in FIG. 15A). In some embodiments, communication module 220 may communicate with cyber security module 1530 to perform secure communication with nearby devices and external networks.

In some embodiments, communication module 220 may transmit an alert message from a secondary vehicle to a primary vehicle that may have a malfunction. In some embodiments, communication module 220 may transmit a broadcast message from the primary vehicle to surrounding vehicles regarding a malfunction of the primary vehicle.

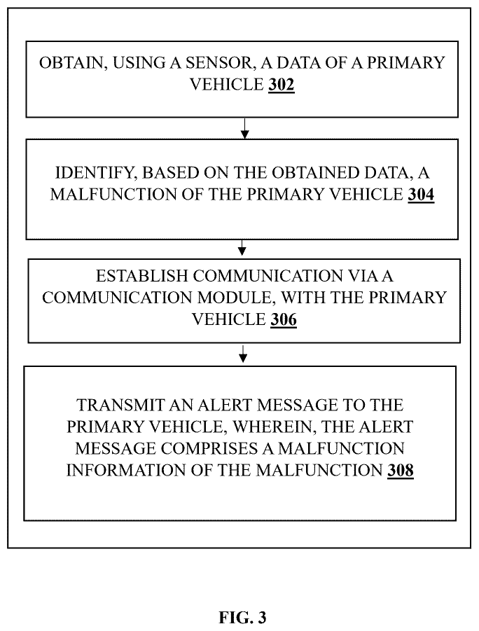

FIG. 3 illustrates a flow chart describing a method for providing an alert message according to an embodiment.

In some embodiments, the method shown in FIG. 3 may be carried out by a processor using instructions stored in a memory that, when executed, cause the processor to carry out the method. In an embodiment, the method as shown in FIG. 3 may be performed by system 100 as shown in FIG. 1.

Referring to FIG. 3, the method may, at step 302, obtain, using a sensor, data of a primary vehicle. Method may, at step 304, identify, based on the obtained data, a malfunction of the primary vehicle. The method may, at step 306, establish communication via a communication module, with the primary vehicle. The method may, at step 308, transmit an alert message to the primary vehicle, wherein, the alert message comprises malfunction information of the malfunction.

In an embodiment, the data of the primary vehicle may comprise at least one of a headlight display, a brake light display, a taillight display, a turn indicator display, a lane change by the primary vehicle, a door, a trunk, a tire, and visible emissions in exhaust from the primary vehicle. The data may relate to a malfunction of the primary vehicle. Examples of malfunction may include the headlight may not be working, the brake light may not be working, the taillight may not be working, the turn indicator may not be working, the primary vehicle may change its lane without giving an indication, the door may be unlocked, the trunk may be unlocked, the tire may be flat, and there may be visible emissions in exhaust, such as smoke, soot, and particulate matter, of the primary vehicle.

In some embodiments, the method may further determine location information of occurrence of the malfunction. In an embodiment, the method may further determine a time information of occurrence of the malfunction. In an embodiment, the method may further determine image information of the malfunction. In an embodiment, the method may further determine video information of the malfunction.

In some embodiments, the malfunction information may comprise at least one of a location information of occurrence of the malfunction, a time information of occurrence of the malfunction, image information of the malfunction, video information of the malfunction, a type of the malfunction, a severity of the malfunction, and a repetition of the malfunction.

In an embodiment, the communication may be initiated based on an input received from an occupant of the secondary vehicle. In an embodiment, the communication may be initiated automatically by the secondary vehicle. In an embodiment, the method may further perform object recognition with the data obtained from the sensor.

In an embodiment, the method may transmit, a start signal to the primary vehicle to check for communication compatibility; transmit, the alert message based on an acknowledgement received from the primary vehicle; and inhibit, transmission of the alert message based on absence of acknowledgement received from the primary vehicle. In an embodiment, the method may evaluate the malfunction for an unsafe condition for the primary vehicle; and transmit, the malfunction information to at least one other vehicle proximate to the secondary vehicle.

In an embodiment, the sensor may comprise one or more of a radar-based sensor, a LAser Detection And Ranging (LADAR) sensor, a Light Detection and Ranging (LIDAR) sensor, a camera, an infrared camera, a night vision camera, and a thermal camera, a vision-based sensor, a light-based sensor, an infrared sensor, an optical sensor, a temperature sensor, a GPS sensor, an audio sensor, and stereo vision sensor. In an embodiment, the communication module comprises a vehicle-to-everything (V2X) telematics communication module. In an embodiment, the communication module is enabled for at least one of a vehicle-to-vehicle communication, vehicle-to-infrastructure communication, and vehicle-to-everything communication. In an embodiment, the vehicle-to-vehicle communication comprises short-range communication. In an embodiment, the communication module may transmit the alert message to a cloud-based service, wherein the alert message is accessible to a subscriber of the cloud-based service. In an embodiment, the communication module may transmit the alert message to a safety application, wherein the safety application is accessible to other vehicles to receive the alert message.

In an embodiment, the system of the secondary vehicle may initiate communication with the primary vehicle. Once, the communication is established, an indication to the primary vehicle notifying that the primary vehicle entered into the lane without providing a visual indication may be transmitted to the primary vehicle. The system of the secondary vehicle can provide the location of where the incident occurred, a time value when the incident occurred and a video clip of the primary vehicle entering into the lane without providing a visual indication. In another embodiment, the communication may be provided when the system detects no visual alerts (e.g., no blinking light or display of brake lights when car is changing lanes or slowing down) are when expected. For example, if a vehicle enters its lane without visual indication (no turn signal light blinking) or a vehicle slows down significantly but no brake lights are on.

The system may be used as a teaching tool wherein the new driver may be informed about the physical actuation that was not provided in a practice run. In an embodiment, the system may be used as a teaching tool wherein a new driver may be driving a vehicle which does not have any malfunction, and a secondary vehicle may monitor the visual displays of the vehicle, such as turn indicators, to alert the new driver that a lane was changed but the turn indicator was not turned on. For example, the new driver did not use the blinker three times. The secondary vehicle may, during the practice run, detect the visual indications that were not provided and message the same to the vehicle the new driver is driving.

In an embodiment, the secondary vehicle may obtain information on a possible high speed of a primary vehicle. The secondary vehicle may transmit an alert message to the primary vehicle which may include information on the speed limits in the particular area where the vehicles are currently being driven.

In an embodiment, the primary vehicle may not be using any kind of visual indicators, such as blinkers, brakes, turning signal while changing a lane, or the headlights are not on all the way up, or not bright enough. The primary vehicle may receive an alert message with information on the malfunction, and then it may propagate the alert message to the infotainment system. In an example, the message may inform the driver of the primary vehicle that the vehicle made a left turn, three minutes ago, and there was no visual indicator provided. The alert message may include a GPS location of the occurrence of the malfunction, the time of the day of occurrence of the malfunction, a picture of the primary vehicle or a recording of the primary vehicle and then transmit the alert message to the primary vehicle. The authentication of the message is carried out by the primary vehicle which may include validation and confirmation of the message.

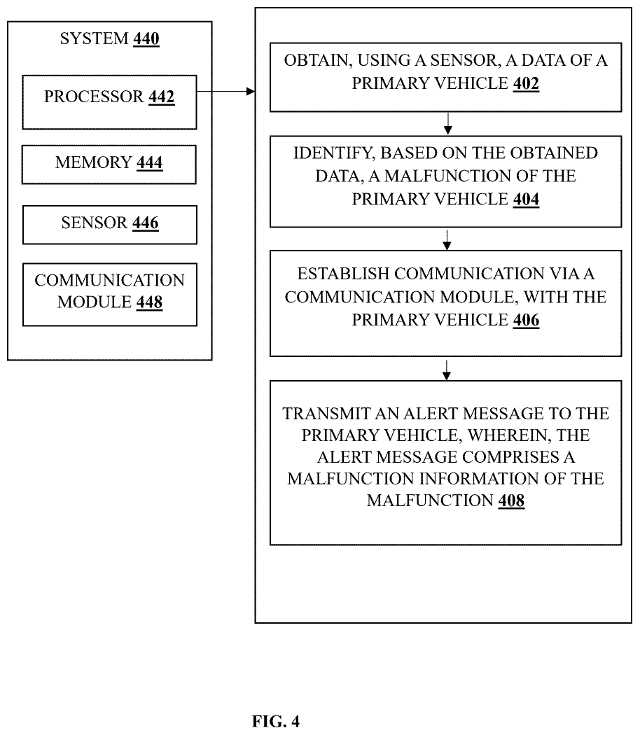

FIG. 4 illustrates a block diagram of the system implementing the method according to an embodiment. According to an embodiment, disclosed is system 440 comprising processor 442, memory 444, sensor 446, and communication module 448, wherein the memory 444 storing processor-executable instructions, which on execution, cause the processor 442 to: obtain, using the sensor 446, data of a primary vehicle at step 402; identify, based on the obtained data, a malfunction of the primary vehicle at step 404; establish communication, via the communication module 448, with the primary vehicle at step 406; and transmit, an alert message to the primary vehicle, wherein, the alert message comprises malfunction information of the malfunction; and wherein the system 440 is configured to be a component of a secondary vehicle at step 408.

In an embodiment, the data may comprise at least one of a headlight display, a brake light display, a taillight display, a turn indicator display, a lane change by the primary vehicle, a door, a trunk, a tire, and visible emissions in exhaust from the primary vehicle.

In an embodiment, the system 440 may further determine location information of occurrence of the malfunction. In an embodiment, the system 440 may determine a time information of occurrence of the malfunction. In an embodiment, the system 440 may determine image information of the malfunction. In an embodiment, the system may determine video information of the malfunction. According to an embodiment, the malfunction information comprises at least one of a location information of occurrence of the malfunction, a time information of occurrence of the malfunction, image information of the malfunction, video information of the malfunction, a type of the malfunction, a severity of the malfunction, and a repetition of the malfunction. According to an embodiment, the communication is initiated based on an input received from an occupant of the secondary vehicle. According to an embodiment, the communication is initiated automatically by the secondary vehicle. In some embodiments, the processor-executable instructions, which on execution, cause the processor to perform object recognition with the data obtained from the sensor. Object recognition analyzes images obtained from the camera and other sensors included with the secondary vehicle to identify a malfunction. For example, images taken by the secondary vehicle of a roadway may include a vehicle that changed its lane without giving a turn signal indication, and the images may be analyzed to identify that the vehicle has a malfunction, as its turn signal is not working. During object recognition the processor determines a portion of the image including the malfunction using object recognition techniques, such as convolutional neural networks (CNNs). Once the portion of the image including the malfunction is identified, the processor crops the image, so that a portion of the image, for example, the majority of the image, depicts the malfunction. Object recognition via the processor may be performed using machine learning algorithms by performing video analytics of a real-time video through the artificial intelligence model and an image processing of an image through the artificial intelligence model.

In an embodiment of the system, the processor 442 is configured to transmit a start signal to the primary vehicle to check for communication compatibility; transmit the alert message based on an acknowledgement received from the primary vehicle; and inhibit transmission of the alert message based on absence of acknowledgement received from the primary vehicle. In an embodiment of the system the processor is configured to evaluate the malfunction for an unsafe condition for the primary vehicle; and transmit the malfunction information to at least one other vehicle proximate to the secondary vehicle.

In an embodiment, the system 440 comprises a plurality of sensors. The sensors may comprise at least one of a radar-based sensor, a LAser Detection And Ranging (LADAR) sensor, a Light Detection and Ranging (LIDAR) sensor, a camera, an infrared camera, a night vision camera, and a thermal camera, a vision-based sensor, a light-based sensor, an infrared sensor, an optical sensor, a temperature sensor, a GPS sensor, an audio sensor, and stereo vision sensor. The camera may comprise a revolving camera configured to obtain an accurate visual information of the display. In an embodiment, the communication module 448 comprises a vehicle-to-everything (V2X) telematics communication module. In an embodiment, the communication module 448 is enabled for at least one of a vehicle-to-vehicle communication, vehicle-to-infrastructure communication, and vehicle-to-everything communication. In an embodiment, the vehicle-to-vehicle communication comprises short-range communication.

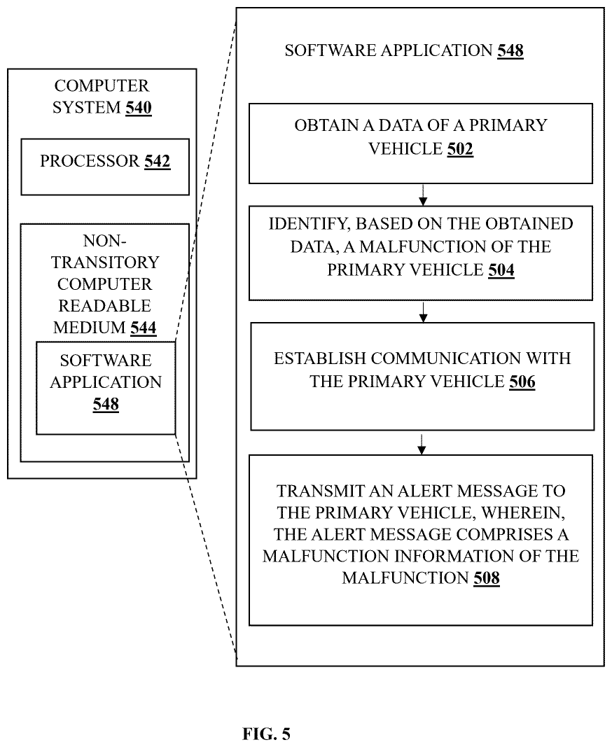

FIG. 5 illustrates a block diagram of the method executed by non-transitory computer-readable medium 544 according to an embodiment.

According to an embodiment, disclosed is non-transitory computer-readable medium 544 having stored thereon instructions executable by computer system 540 to perform operations comprising: obtaining, data of a primary vehicle at step 502; identifying, a malfunction of the primary vehicle based on the data at step 504; establishing, communication with the primary vehicle at step 506; and transmitting, an alert message to the primary vehicle, wherein, the alert message comprises a malfunction information of the malfunction at step 508. A software application 548 may be stored on non-transitory computer-readable medium 544 and executed by processor 542 of the computer system 540. In an embodiment, the data of the primary vehicle may comprise at least one of a headlight display, a brake light display, a taillight display, a turn indicator display, a lane change by the primary vehicle, a door, a trunk, a tire, and visible emissions in exhaust from the primary vehicle.

In some embodiments, non-transitory computer-readable medium 544 further comprises instructions to perform operations comprising: determining a location information of occurrence of the malfunction, determining a time information of occurrence of the malfunction, determining image information of the malfunction, and determining video information of the malfunction.

In an embodiment, the malfunction information may comprise at least one of a location information of occurrence of the malfunction, a time information of occurrence of the malfunction, image information of the malfunction, video information of the malfunction, a type of the malfunction, a severity of the malfunction, and a repetition of the malfunction. In an embodiment, communication is initiated based on an input received from an occupant of the secondary vehicle. In an embodiment, communication is initiated automatically by the secondary vehicle.

In an embodiment, non-transitory computer-readable medium 544 further comprises instructions to perform operations comprising: transmitting, a start signal to the primary vehicle to check for communication compatibility; transmitting, the alert message based on an acknowledgement received from the primary vehicle; and inhibiting, transmission of the alert message based on absence of acknowledgement received from the primary vehicle. In an embodiment, non-transitory computer-readable medium 544 further comprises instructions to perform operations comprising: evaluating, the malfunction for an unsafe condition for the primary vehicle; and transmitting, the malfunction information to at least one other vehicle proximate to the secondary vehicle.

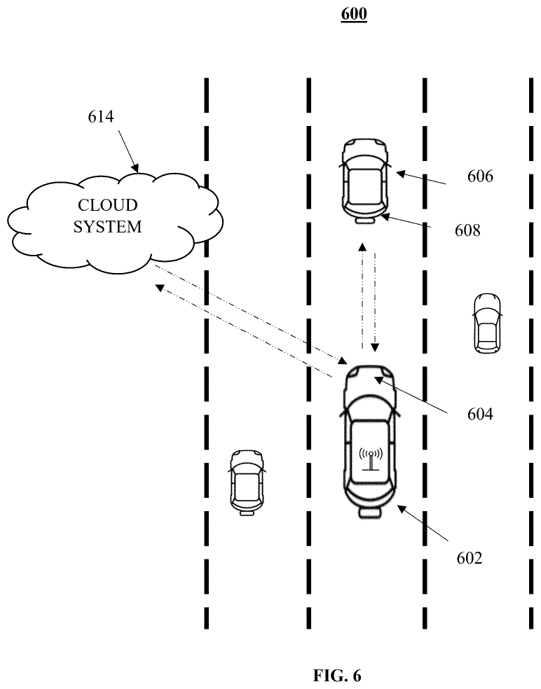

FIG. 6 illustrates a block diagram 600 of an example of an environment and system for identification of malfunction of primary vehicle according to an embodiment.

The block diagram 600 may include a secondary vehicle 602 and a primary vehicle 606. The secondary vehicle 602 may have sensor(s) 604 to obtain data of the primary vehicle 606. In an embodiment, the primary vehicle 606 may have a malfunction 608. In an embodiment, the malfunction may be a brake light malfunction, wherein the primary vehicle 606 slowed down however the brake light did not blink. The secondary vehicle 602 may identify the malfunction of the primary vehicle 606 based on the obtained data. In an embodiment, the secondary vehicle 602 may establish communication with the primary vehicle 606 and transmit an alert message to the primary vehicle 606. The alert message may comprise malfunction information regarding the malfunction of the primary vehicle 606. There may be other vehicles in the environment that may be affected by the malfunction of the primary vehicle 606. In an embodiment, the secondary vehicle 602 may transmit the alert message to a cloud system 614, for other vehicles to access the malfunction information of the primary vehicle 606.

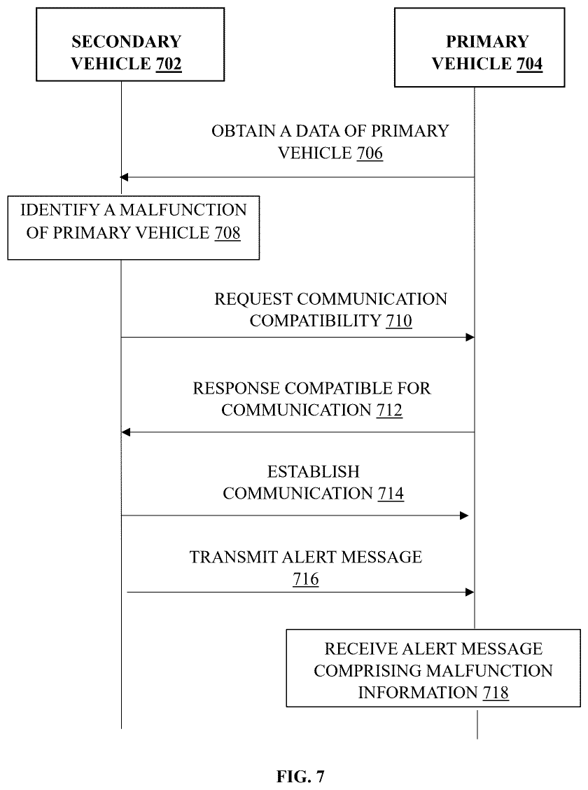

FIG. 7 illustrates a message flow diagram between the secondary vehicle 702 and the primary vehicle 704 according to an embodiment.

Referring to FIG. 7, the secondary vehicle 702 in communication with the primary vehicle 704 is shown. In an embodiment, the secondary vehicle 702 may obtain data of the primary vehicle 704 at step 706. In some embodiments, the secondary vehicle 702 may identify a malfunction of the primary vehicle 704 based on the obtained data at step 708. The secondary vehicle 702 may request communication compatibility with the primary vehicle 704 at step 710. The primary vehicle 704 may acknowledge that it is compatible for communication at step 712. The secondary vehicle 702 may establish communication with the primary vehicle 704 at step 714. The secondary vehicle 702 may transmit the alert message to the primary vehicle 704 at step 716, wherein, the alert message comprises malfunction information of the malfunction. The primary vehicle receives the alert message comprising malfunction information at step 718.

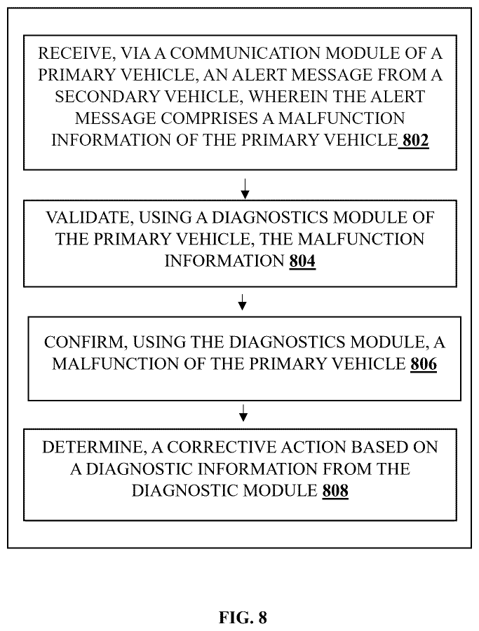

FIG. 8 illustrates a flow chart describing a method of a primary vehicle according to an embodiment.

In some embodiments, the method shown in FIG. 8 may be carried out by a processor using instructions stored in a memory that, when executed, cause the processor to carry out the method. In an embodiment, the method as shown in FIG. 8 may be performed by system 100 as shown in FIG. 1.

Referring to FIG. 8, the method may, at step 802, receive, via a communication module of a primary vehicle, an alert message from a secondary vehicle, wherein the alert message comprises a malfunction information of the primary vehicle. Method may, at step 804, validate, using a diagnostics module of the primary vehicle, the malfunction information. The method may, at step 806, confirm, using the diagnostics module, a malfunction of the primary vehicle. The method may, at step 808, determine a corrective action based on diagnostic information from the diagnostic module.

In an embodiment, the malfunction may comprise at least one of a headlight malfunction, a brake light malfunction, a taillight malfunction, and a turn indicator malfunction, a lane change without visual indication, an unlocked door, an unlocked trunk, a tire malfunction, and visible emissions in exhaust from the primary vehicle. In an embodiment, the method may further identify a malfunctioning component based on the malfunction information of the primary vehicle. The method may ensure a physical activation for the malfunctioning component provided by a driver of the primary vehicle, in case of a headlight malfunction, a brake light malfunction, a taillight malfunction, a turn indicator malfunction, a lane change without visual indication, an unlocked door, and an unlocked trunk. The primary vehicle may be configured to perform on-board diagnostics using the diagnostic module to monitor the overall operation of its mechanical and electrical systems and components.

In an embodiment, the method may further transmit, via the communication module, a broadcast message to a surrounding vehicle. The broadcast message may comprise the malfunction information. The broadcast message may comprise a display of a function of the malfunctioning component as an augmented reality.

In an embodiment, the corrective action may be classified based on the diagnostic information. In case the diagnostic information confirms that there is a malfunction in the working of the brake light, it may be taken as high priority as when the vehicle slows down and the brake light display does not work, the chances of collision can increase. To avoid such a situation the method may classify brake light not working as a high priority malfunction. In some embodiments, the method may further display a Do-It-Yourself (DIY) video, to correct the malfunction, on an infotainment system of the primary vehicle. In an embodiment, the method may locate the malfunctioning component on an online website; and place a purchase order for the malfunctioning component. In an embodiment, the method may locate a service station; communicate the diagnostic information to the service station; and receive a confirmation from the service station regarding an availability of a service to correct the malfunction. In an embodiment, the method may receive a list of available appointment slots from the service station; and transmit a user preferred appointment slot to the service station. In an embodiment, the method may prioritize an appointment with the service station based on a severity of the malfunction. In an embodiment, the method may determine a destination location for the primary vehicle; and determine a new route for the primary vehicle, from a current location to the destination location, wherein the new route is determined based on a minimal use of a malfunctioning component of the primary vehicle.

In an embodiment, the primary vehicle may filter the message that it receives from a secondary vehicle or from multiple secondary vehicles, notifying the primary vehicle of a malfunction in the primary vehicle. In an embodiment, the primary vehicle may not know which vehicle actually transmitted the alert message to it. In case a message about the same malfunction is received multiple times, the primary vehicle may place a broadcast message informing the surrounding vehicles that it is aware of the malfunction. The primary vehicle may filter out or ignore the messages on a malfunction that it has identified. The primary vehicle may further store the alert message. In an embodiment, the diagnostic module of the primary module may check that a physical activation for a headlight was provided by the driver, and further check that the headlight is working but the brightness has lowered. The diagnostic module may be configured to derive vehicle diagnostic information from the diagnostic data received from the ECU and/or various other vehicle systems, and to communicate that information to the driver and/or the communication module, for V2X transmission. In an embodiment, the diagnostic module may be configured to communicate the diagnostic information to a cellular network communication circuit, for communicating the diagnostic information to a remote diagnostic database for further analysis, the results of which may be communicated for display in the vehicle, e.g., on the infotainment system, or on a handheld wireless communication device used by the driver, such as a smart phone.

The corrective action by the primary vehicle may include setting an appointment with a service station. The primary vehicle may provide a severity of the malfunction to the service station and request an appointment on a priority basis to repair the malfunction. In the event that the nearest service station does not have the malfunctioning component, the primary vehicle may contact the next service station for an appointment. In case the next service station has the malfunctioning component, the primary vehicle may book an appointment slot. In case the malfunctioning component is not available nearby, and the nearest service station that has the malfunctioning component is, say, so far that the driver or the owner of the vehicle may not be able to go there, the primary vehicle may look for the malfunctioning component within a particular range from the location of the primary vehicle. In another embodiment, the primary vehicle may look for the malfunctioning component online. The primary vehicle may continue to find the malfunctioning component until it is found.

In another aspect, the system of the primary vehicle may establish communication with the preferred or nearest mechanic to repair the malfunction or the non-functioning component. The system can also order the required part or select the shop that has the part. In an embodiment, the system can display a DIY video and identify parts needed to make the repair including ordering the part. In an embodiment, the route may be modified to limit the use of the malfunctioning component until it is repaired or replaced. In an embodiment, the route may be modified to eliminate using the turn signals. In case the right turn signal is not working, the primary vehicle may determine a new route and reroute the primary vehicle from the current location to the destination location where the use of the right turn signal may be limited. In an example, the primary vehicle may be an autonomous vehicle and the notification may be transmitted to a navigation and routing system of the vehicle. The notification may cause the navigation and routing system to reroute the primary vehicle to have minimal use of the malfunctioning component until it reaches the destination.

In another embodiment, the primary vehicle may locate the malfunctioning component at a registered dealer and place a purchase order for a delivery or a buy-in of the malfunctioning component at an address provided by the driver of the primary vehicle. The financial information for placing the purchase order online may be pre-fed in the primary vehicle or provided by the owner/driver of the primary vehicle on the spot. Once the ordered component is received the primary vehicle may receive an alert regarding the same and thereafter the primary vehicle may schedule an appointment with a service station to get the malfunction repaired or malfunctioning component replaced in the primary vehicle.

In an embodiment, the problem with the primary vehicle may be fixed by the user of the primary vehicle based on a DIY video that may be displayed on the infotainment system of the primary vehicle. The primary vehicle may place a purchase order and once the malfunctioning component is received, display a DIY video for the user. The DIY images or video may be displayed on the infotainment system of the primary vehicle or may be transmitted to a user phone or an application.

In an embodiment, when an indication from a secondary vehicle is received, the system of the primary vehicle may determine if the physical activation was provided (e.g., was the turn signal actuated or was the brake applied). If physical activation was provided, then the system determines a fault and alerts the driver to take action. Until the lights are repaired, the system can provide an alternate means to communicate physical actions. For example, the system can use other means to notify other drivers of the action (e.g., turning or braking). The system can broadcast a message that is received by surrounding cars notifying of action being taken and that no visual displays are provided. When the surrounding vehicle receives such a broadcast message, it determines if the message is applicable to it based on location in respect to the vehicle broadcasting the message. In an example, the broadcast message may be rejected by the surrounding vehicle based on a location of the surrounding vehicle with respect to the primary vehicle. For example, if the vehicle that is broadcasting is behind the surrounding vehicle, the message indicating that the primary vehicle is braking will be ignored. However, if the broadcast message includes information regarding turning of the primary vehicle, it may alert the driver that the vehicle behind it is turning into its lane. In an embodiment, the broadcast message is sent by the communication module as soon as the malfunction is confirmed. In another embodiment, the system waits a certain period of time and then broadcasts the message. In another embodiment, the system provides an option to the user if it can broadcast an emergency message. In addition, the primary vehicle can similarly transmit a similar broadcast message to any vehicle traveling within a predefined window.

Additionally, an embodiment may be directed to methods of warning a driver of a vehicle, of a primary vehicle with a malfunctioning component, approaching its vicinity. Such methods include receiving an alert message communicated over the V2V network indicating that the primary vehicle has initiated that alert, processing the message to identify the location and relative direction of the primary vehicle, and producing a virtual audio alert sound within the vehicle that is suggestive of a physical alert sound such as a siren, or horn. In some embodiments the pitch of the virtual alert can, for example, mimic the Doppler effect produced by a real siren or horn-approaching or receding at the actual relative velocities of the receiving vehicle and the vehicle producing the alert. The alert message can include, for example, telemetry data such as vehicle speed, direction, GPS coordinates, and acceleration or deceleration rates of the primary vehicle as the primary vehicle changes from a general path of travel “B”, which can be parallel to the path of travel “A” of the surrounding vehicle, into or toward a modified path of travel. The data representing the path of travel may indicate an intersection with the path of travel “A” of the surrounding vehicle, thereby warranting a warning to the driver of the surrounding vehicle that the primary vehicle may intersect the path of travel “A”.

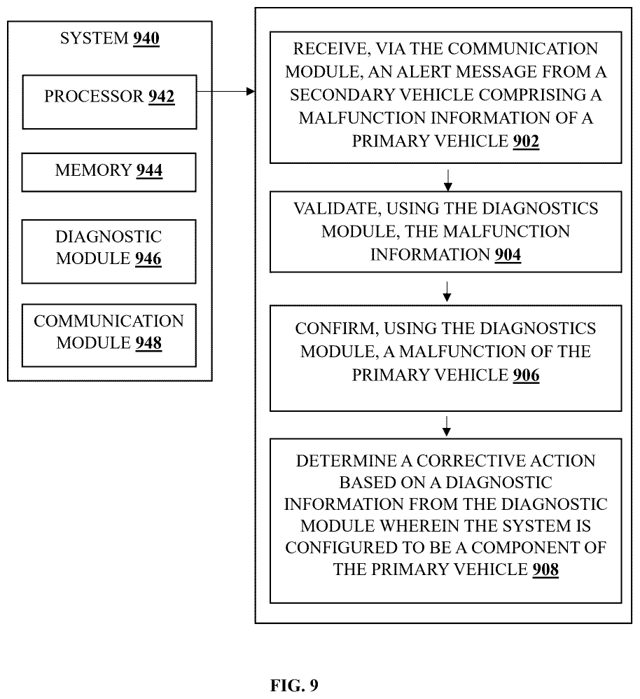

FIG. 9 illustrates a block diagram of the system 940 implementing the method according to an embodiment. According to an embodiment, disclosed is system 940 comprising processor 942, memory 944, diagnostic module 946, and communication module 948, wherein memory 944 storing processor-executable instructions, which on execution, cause the processor to: receive, via the communication module 948, an alert message from a secondary vehicle comprising malfunction information of a primary vehicle at step 902; validate, using the diagnostics module 946, the malfunction information at step 904; confirm, using the diagnostics module 946, a malfunction of the primary vehicle at step 906; and determine a corrective action based on diagnostic information from the diagnostic module 946, wherein the system is configured to be a component of the primary vehicle at step 908.

In an embodiment, the malfunction may comprise at least one of a headlight malfunction, a brake light malfunction, a taillight malfunction, and a turn indicator malfunction, a lane change without visual indication, an unlocked door, an unlocked trunk, a tire malfunction, and visible emissions in exhaust from the primary vehicle.

In some embodiments, the processor-executable instructions, which on execution, cause the processor to: identify a malfunctioning component based on the malfunction information of the primary vehicle. In some embodiments, the system may further ensure a physical activation for the malfunctioning component was provided by a driver of the primary vehicle, in case of a headlight malfunction, a brake light malfunction, a taillight malfunction, a turn indicator malfunction, a lane change without visual indication, an unlocked door, and an unlocked trunk.

According to an embodiment, the system may further transmit, via the communication module, a broadcast message to a surrounding vehicle. The broadcast message may comprise the malfunction information. The broadcast message may comprise a display of a function of the malfunctioning component as an augmented reality.

In an embodiment, the corrective action may be classified based on the diagnostic information. In some embodiments, the processor-executable instructions, which on execution, cause the processor: to display a DIY video, to correct the malfunction on an infotainment system of the primary vehicle. In an embodiment of the system the processor is configured to locate the malfunctioning component on an online website; and place a purchase order for the malfunctioning component.

In some embodiments, the processor-executable instructions, which on execution, cause the processor to locate a service station; communicate the diagnostic information to the service station; and receive a confirmation from the service station regarding an availability of a service to correct the malfunction.

In an embodiment, the processor-executable instructions, which on execution, cause the processor to receive a list of available appointment slots from the service station, and transmit a user preferred appointment slot to the service station. In an embodiment, the system may prioritize an appointment with the service station based on a severity of the malfunction. In an embodiment, the processor-executable instructions, which on execution, cause the processor to determine a destination location for the primary vehicle; and determine a new route for the primary vehicle, from a current location to the destination location, wherein the new route is determined based on a minimal use of a malfunctioning component of the primary vehicle.

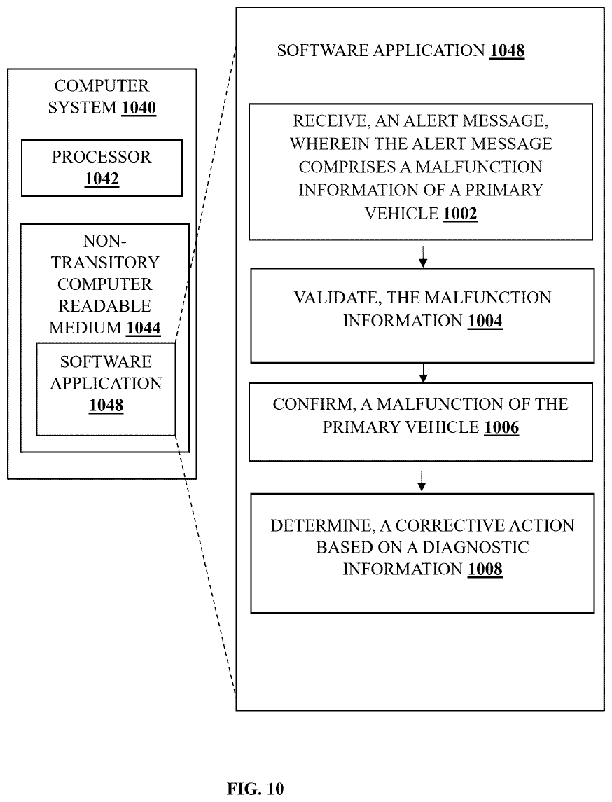

FIG. 10 illustrates a block diagram of the method executed by the non-transitory computer-readable medium according to an embodiment.

According to an embodiment, disclosed is a non-transitory computer-readable medium 1044 having stored thereon instructions executable by computer system 1040 to perform operations comprising: receiving, an alert message, wherein the alert message comprises a malfunction information of a primary vehicle at step 1002; validating, the malfunction information at step 1004; confirming, a malfunction of the primary vehicle at step 1006; and determining, a corrective action based on diagnostic information at step 1008. A software application 1048 may be stored on non-transitory computer-readable medium 1044 and executed by processor 1042 of computer system 1040.

In an embodiment, the malfunction may comprise at least one of a headlight malfunction, a brake light malfunction, a taillight malfunction, and a turn indicator malfunction, a lane change without visual indication, an unlocked door, an unlocked trunk, a tire malfunction, and visible emissions in exhaust from the primary vehicle.

In an embodiment, non-transitory computer-readable medium 1044 further comprises instructions to perform operations comprising identifying a malfunctioning component based on the malfunction information of the primary vehicle. In some embodiments, non-transitory computer-readable medium 1044 further comprises instructions to perform operations comprising transmitting a broadcast message. The broadcast message may comprise the malfunction information. The broadcast message may comprise a display of a function of the malfunctioning component as an augmented reality. In an embodiment, the corrective action may be classified based on a severity of the diagnostic information. In an embodiment, non-transitory computer-readable medium 1044 further comprises instructions to perform operations comprising displaying a DIY video to correct the malfunction on an infotainment system of the primary vehicle.

In an embodiment, non-transitory computer-readable medium 1044 further comprises instructions to perform operations comprising locating, the malfunctioning component on an online website; and placing, a purchase order for the malfunctioning component. In an embodiment, non-transitory computer-readable medium 1044 further comprises instructions to perform operations comprising locating, a service station; communicating, the diagnostic information to the service station; and receiving, a confirmation from the service station regarding an availability of a service to correct the malfunction. In an embodiment, non-transitory computer-readable medium 1044 further comprises instructions to perform operations comprising receiving, a list of available appointment slots with the service station; and transmitting, a user preferred appointment slot to the service station. In an embodiment, non-transitory computer-readable medium 1044 further comprises instructions to perform operations comprising prioritizing, an appointment with the service station based on a severity of the malfunction. In an embodiment, non-transitory computer-readable medium 1044 further comprises instructions to perform operations comprising determining, a destination location for the primary vehicle; and determining, a new route for the primary vehicle from a current location to the destination location, wherein the new route is determined based on a minimal use of a malfunctioning component of the primary vehicle.

Table 1 shows example messages in Dedicated Short-Range Communications (DSRC) message format. Table 1 shows: (i) Basic Safety Message (BSM) format: BSM is a fundamental message type in DSRC, used for transmitting information about a vehicle's status, location, and movement to other vehicles in the area.

| Message Type | Message Protocol Example | Explanation |
|---|---|---|
| Basic Safety | Header: | This message is a BSM that includes |
| Message | Message ID: 0x20 | information about a vehicle with ID |
| (BSM) format: | Protocol version: 1 | 0x1234, traveling at a speed of 60 mph |
| | Data: | in the direction of 180 degrees. The |
| | Vehicle ID: 0x1234 | latitude and longitude coordinates |
| | Speed: 60 mph | indicate the vehicle's position, and the |
| | Heading: 180 degrees | timestamp indicates when the message |
| | Latitude: 37.7749 degrees | was generated. |
| | Longitude: −122.4194 degrees | |
| | Timestamp: 0x12345678 | |
| Signal Phase | Header: | This message is a SPAT message that |
| and Timing | Message ID: 0x0A | includes information about an |
| (SPaT) format: | Protocol version: 1 | intersection with ID 0x5678. The |
| | Data: | movement phase state indicates that |
| | Intersection ID: 0x5678 | the traffic signal for a specific |
| | Movement phase state: green | direction is currently green, and the |
| | Time to next phase: 10 seconds | time to the next and following phases |
| | Time to following phase: 30 seconds | indicates when the signal will change. |
| Roadside Alert | Header: | This message is an RSA message that |
| (RSA) format: | Message ID: 0x0B | provides information about a |
| | Protocol version: 1 | construction zone ahead. The distance |
| | Data: | and direction indicate where the |
| | Alert type: construction | construction zone is located relative to |
| | Distance to alert: 500 feet | the receiving vehicle, and the text |
| | Direction: north | message provides additional details |
| | Text message: “Construction zone | about the alert. |
| | ahead. Expect delays.” | |

In the example message, the header contains the message ID and protocol version, while the data section contains specific information about the vehicle, such as its ID, speed, heading, and position. The timestamp indicates when the message was generated and can be used by other vehicles to determine the current status of the transmitting vehicle; (ii) Signal Phase and Timing (SPaT) format: The SPAT message provides information about the current state of traffic signals at an intersection, including which phase is currently active and when the signal will change. This information can be used by vehicles to optimize their driving behavior and avoid collisions. In the example message, the header contains the message ID and protocol version, while the data section includes the ID of the intersection, the state of the movement phase, and the time remaining until the next and following phases; (iii) Roadside Alert (RSA) format: The RSA message is used to notify vehicles about hazards or other important information on the road ahead, such as construction zones, accidents, or detours. In the example message, the header contains the message ID and protocol version, while the data section includes the type of alert (construction), the distance to the alert, the direction of the alert, and a text message providing additional details about the alert.

According to an embodiment, there are other possible elements that can be included in each message format, for example, the BSM format may also include information on: acceleration, size and weight, vehicle safety extensions including Brakes, Lights, Wipers, Transmission and powertrain, Vehicle dimensions and Vehicle identification information including identification number and vehicle type.

There are several other message formats available in DSRC protocol besides the three examples provided earlier. Some of these message formats include: MAP (Message Assistance for Path Provisioning) format: This message provides a map of the road network, including information about the road layout, speed limits, and other relevant details; CAM (Cooperative Awareness Message) format: Similar to the BSM message format, this message provides information about a vehicle's current status, such as speed, position, and heading. CAM messages are typically sent at a higher frequency than BSM messages to support more accurate situational awareness; DENM (Decentralized Environmental Notification Message) format: This message provides information about environmental conditions that may affect driving, such as weather conditions, visibility, and road surface conditions; emergency vehicle format: This message provides information about emergency vehicles, such as their location and direction of travel, to help other drivers safely navigate around them; TCI (Traffic Control Information) format: This message provides information about traffic conditions, such as congestion, accidents, and construction zones, to help drivers make informed decisions about their routes.

Overall, the various message formats available in DSRC protocol support a wide range of use cases, from basic vehicle-to-vehicle communication to more complex applications such as real-time traffic management and emergency response.

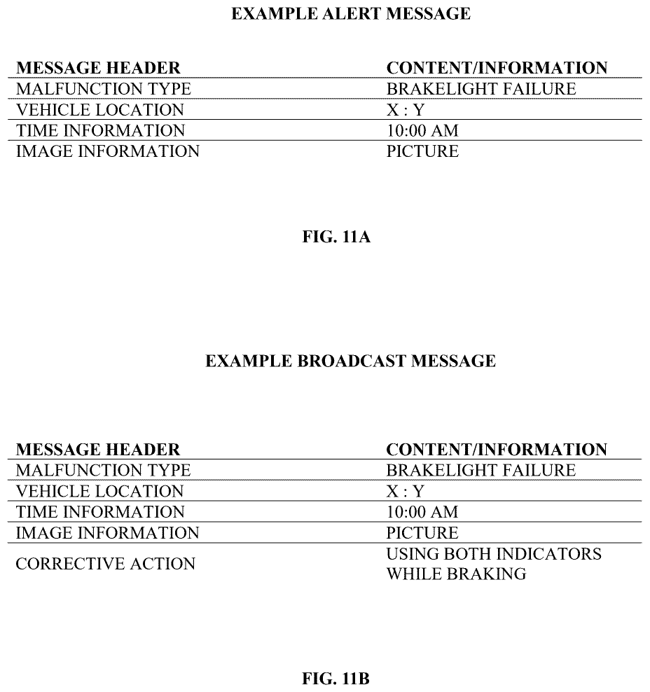

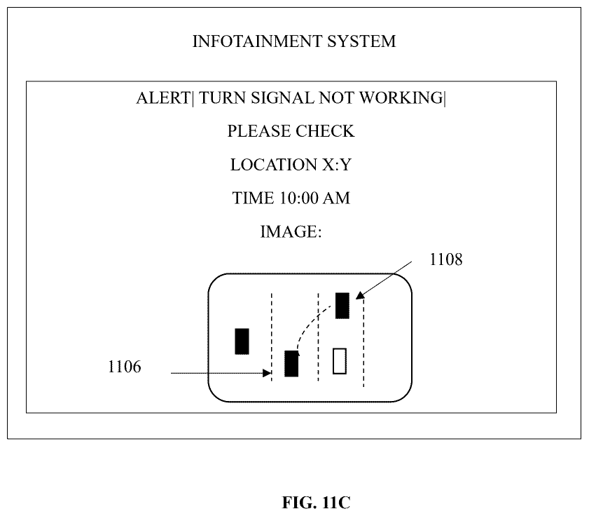

FIG. 11A illustrates an example alert message and content of the message that may be used for communication between the secondary vehicle and the primary vehicle according to an embodiment.

The alert message may comprise fields such as malfunction type, a location information of occurrence of malfunction, a time information of occurrence of the malfunction, image information of the malfunction. In an embodiment, the alert message may further comprise video information of the malfunction.

The alert message may include a header and a body. The header may include fields, such as a message type identifier (ID) and a generation time of the message. The body may include malfunction information fields that provide information on the malfunction. In an example, the fields may include one or more of: a malfunction, a time of occurrence of the malfunction, a location of occurrence of the malfunction, and/or sensor information, such as sensor readings, data or information.

The malfunction type may be an identification number, or a tag associated with the type of malfunction configured to identify and recognize the malfunction. In an embodiment, the alert message may comprise other particulars such as the severity of the malfunction, and a repetition of the malfunction, etc. The alert message is an example of an alert sent by the system of the secondary vehicle to the primary vehicle alerting it of the malfunction.

Location information may also be included of the detected malfunction or location of when the incident information was recorded. The location information may include one or more of latitude, longitude or elevation. The location information may include location information of the incident and/or of the recording of the malfunction.

As an example, the alert message may include driving rating information based on the driving of the primary vehicle. The primary vehicle may be configured to filter or ignore driving rating information received from the nearby vehicle(s)/driver(s) that provide an excessive number of ratings, or that have a poor driving rating, or that provide negative driving ratings a majority of the time and/or that provide positive driving ratings a majority of the time just to name a few possibilities.

According to several aspects, the system and method may utilize V2X Basic safety message information from multiple V2X enabled vehicles in a cluster of traffic to generate a steady state filter model based on the history of the primary vehicle and generate an alert when a primary vehicle develops a transient condition to the filter model. In this manner, the information can be utilized for ADAS technology by utilizing V2X capability and ADAS computing systems to predict harmful traffic conditions when they are not necessarily line-of-sight to the other vehicles.

In an embodiment, the system may send and receive alert messages in a vehicle mobility data format, for example such as Basic Safety Message (BSM) format, which is provided in accordance with SAE J2735 BSM. Vehicle mobility data can include items such as latitude, longitude, time, heading angle, speed, lateral acceleration, longitudinal acceleration, yaw rate, throttle position, brake status, steering angle, headlight status, wiper status, external temperature, turn signal status, vehicle length, vehicle width, vehicle mass, and bumper height. The vehicle mobility data may be received via an antenna system of the vehicle and is communicated to a V2X telematics communication module. In the V2X telematics communication module, the vehicle mobility data is converted to V2X data. In a step, the V2X data may be used to create an alert message of the data representing the status of the primary vehicle.

In an embodiment, icons on a graphical user interface (GUI) or display of the infotainment system of a computer system are re-arranged based on a priority score of the content of the message. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. In all the messages that need a driver's attention, a priority score is provided based on the actions that need to be taken by the user, the time available for the user to receive the displayed message and react with an action, the content of the message, criticality of the user's input/action, sequence of the messages that need to be executed, and safety of the overall scenario. The priority of the messages are evaluated dynamically as the situation is evolving and thus the display icons, positions, and sizes of the text or icon on the display are changed in real time and dynamically. In an embodiment, more than one message is displayed and highlighted as per the situation and the user's actions.

FIG. 11B illustrates an example broadcast message and content of the message that may be used for communication between the primary vehicle and surrounding vehicles according to an embodiment.

The broadcast message may comprise fields such as one or more of a malfunction type, a location information of occurrence of malfunction, a time information of occurrence of the malfunction, image information of the malfunction, and corrective action.

The corrective field may comprise values based on the corrective action being taken by the primary vehicle, such as one of “using both indicators while braking” in case the brake light display of the primary vehicle is malfunctioning. The broadcast message may comprise the same particulars of fields with revised values as contained within the broadcast message when the corrective action value changes. The broadcast message may also comprise same particulars of fields with same values as contained within the alert message. In an embodiment, the broadcast message may also comprise other particulars such as the distance to be travelled by the primary vehicle, route information, etc., for the surrounding vehicles to be aware of the malfunction of the primary vehicle while they are also on the same route.

According to several aspects, the system and method may utilize V2X Basic safety message information from multiple V2X enabled vehicles in a cluster of traffic to generate a steady state filter model based on the history of the primary vehicle and generate a broadcast message when a primary vehicle develops a transient condition to the filter model. In this manner, the information can be utilized for ADAS technology by utilizing V2X capability and ADAS computing systems to predict harmful traffic conditions when they are not necessarily line-of-sight to the other vehicles.

In an embodiment, the system may send and receive broadcast messages in a vehicle mobility data format, for example Basic Safety Message (BSM) format, which is provided in accordance with SAE J2735 BSM. Vehicle mobility data can include items such as latitude, longitude, time, heading angle, speed, lateral acceleration, longitudinal acceleration, yaw rate, throttle position, brake status, steering angle, headlight status, wiper status, external temperature, turn signal status, vehicle length, vehicle width, vehicle mass, and bumper height. The vehicle mobility data may be received via an antenna system of the vehicle and is communicated to a V2X telematics communication module. In the V2X telematics communication module, the vehicle mobility data is converted to V2X data. In a step, the V2X data may be used to create a broadcast message of the data representing the status of the primary vehicle.

FIG. 11C shows an alert message that is displayed in the primary vehicle on an infotainment system of the primary vehicle which includes a graphic that is generated according to an embodiment.

The alert message may comprise the malfunction type and details regarding the malfunction as transmitted from the secondary vehicle. In an embodiment, the image information of the malfunction may comprise an image of the primary vehicle changing a lane without providing visual indication. The primary vehicle may, upon receiving the alert message, validate the malfunction information and confirm a malfunction of the primary vehicle. The primary vehicle is shown as 1106 and the primary vehicle changes its lane without providing a visual indication as shown at 1108. The graphic also shows the surrounding vehicles to provide a clear depiction of the surroundings of the vehicle or the traffic around the vehicle. In an embodiment of the system, the alert message may include more than one graphic of the primary vehicle and the path of the primary vehicle that is displayed on an infotainment system of the primary vehicle.

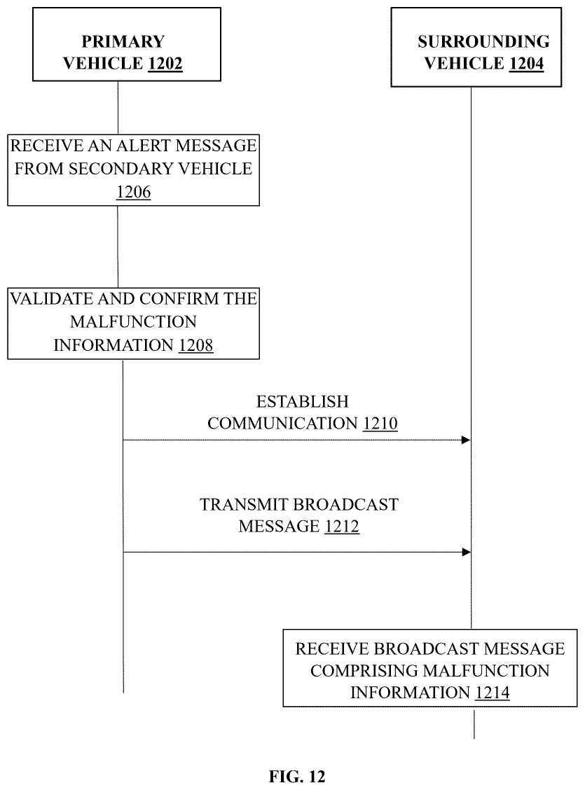

FIG. 12 illustrates a message flow diagram between the primary vehicle and the surrounding vehicle according to an embodiment.

Referring to FIG. 12, the primary vehicle 1202 in communication with the surrounding vehicle 1204 is shown. In an embodiment, the primary vehicle 1202 may receive an alert message from a secondary vehicle at step 1206. In some embodiments, the primary vehicle 1202 may validate the malfunction information and confirm the malfunction of the primary vehicle at step 1208. The primary vehicle 1202 may establish communication with the surrounding vehicle at step 1210. The secondary vehicle 702 may transmit the broadcast message to the surrounding vehicle at step 1212. The broadcast message received by the surrounding vehicle at step 1214, may comprise malfunction information.

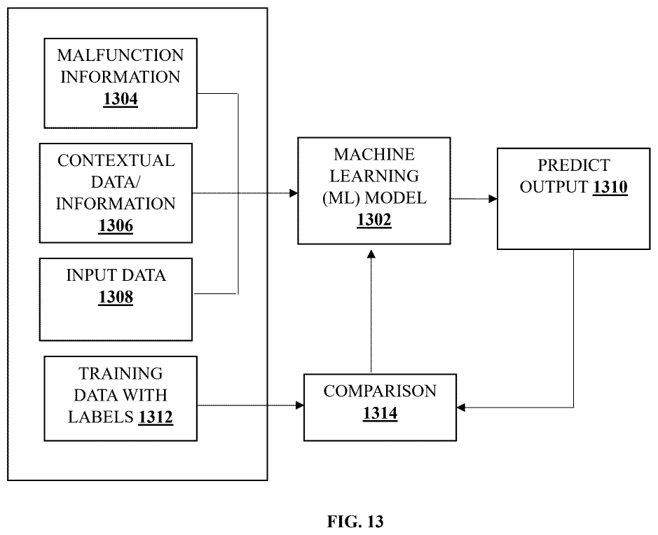

FIG. 13 illustrates an example block diagram for an Artificial Intelligence and Machine Learning (AI/ML) model used in a system according to an embodiment.

Referring to FIG. 13, the machine learning model 1302 may take as input any data associated with malfunction information 1304, contextual data/information 1306, and corrective action data as the input data 1308 and learn to identify features within the data that are predictive of an optimized corrective action for the malfunction of the primary vehicle. The contextual data/information 1306 may include environmental factors, historical factors that may affect the malfunction of the primary vehicle. Training data with labels 1312 may comprise, for example, a historical data of malfunctions and the corrective actions taken. The systems and methods of the present disclosure may also provide data analytics information that may be used later to improve the prediction accuracy of a corrective action for a malfunction of the primary vehicle.

In an embodiment, during training, machine learning model 1302 may process the training data sample (e.g., malfunction information 1304, contextual data/information 1306, and corrective action data as the input data 1308), and, based on the current parameters of machine learning model 1302, predict output 1310 which may be an optimized corrective action. In an embodiment, the real-time sensor data may be processed using one or more machine learning models 1302, trained and based on similar types of data to correctly estimate a corrective action. For example, comparison 1314 may be based on a loss function that measures a difference between the predicted/detected output and training data with labels 1312. Based on the comparison 1314 or the corresponding output of the loss function, a training algorithm may update the parameters of machine learning model 1302 with the objective of minimizing the differences or loss between subsequent predicted output 1310 and corresponding labels 1312. By iteratively training in this manner, machine learning model 1302 may “learn” from the different training data samples and become better at predicting output 1310. In an embodiment, machine learning model 1302 is trained using data which is specific to a malfunction for which the model is used for predicting adjustments to the settings to provide accurate estimation of the corrective action. In an embodiment, machine learning model 1302 is trained using data which is general to the different malfunctions and is used for predicting adjustments for prediction of a corrective action. In an embodiment, the malfunction information may be given weights and provided as an input to the AI/ML system.

Through training, machine learning model 1302 may learn to identify predictive and non-predictive features and apply the appropriate weights to the features to optimize predictive accuracy of machine learning model 1302. In embodiments where supervised learning is used and each training data sample has a label, the training algorithm may iteratively process each training data sample and generate a predicted output 1310. Any suitable machine learning model and training algorithm may be used, including, e.g., neural networks, decision trees, clustering algorithms, and any other suitable machine learning techniques. Once trained, machine learning model 1302 may take input data and detect the objects along with their corresponding confidence score. In an embodiment, machine learning model 1302 is an artificial neural networks (ANN) model.

In one aspect, the present disclosure discusses a method for modifying/adjusting the corrective action based on an artificial intelligence (AI) engine prediction algorithm. The AI engine predicts a corrective action based on the severity of the malfunction. The AI model considers various factors: the malfunction type, the severity of the malfunction, impact on the surrounding vehicles, user preference, etc., for the prediction and estimation of the corrective action.

In an embodiment, the machine learning model 1302 may take as input any data associated with malfunction information 1304, contextual data/information 1306, and routing data as the input data 1308 and learn to identify features within the data that are predictive of an optimized route wherein the use of the malfunctioning component of the primary vehicle is minimal. In an embodiment, during training, machine learning model 1302 may process the training data sample for route optimization, (e.g., malfunction information 1304, contextual data/information 1306, and routing data as the input data 1308), and, based on the current parameters of machine learning model 1302, predict output 1310 may be an optimized route for the primary vehicle. In one aspect, the present disclosure discusses a method for modifying/adjusting the route based on an artificial intelligence (AI) engine based prediction algorithm. The AI engine predicts a route based on minimal usage of the malfunctioning component, the severity of the malfunction, nearest service station, etc. The AI model considers various factors: the malfunction type, the severity of the malfunction, impact on the surrounding vehicles, user preference, etc. for the prediction and estimation of the optimized route.

In an embodiment, the machine learning model is configured to learn using labeled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In some embodiments, the machine learning model is configured to learn from a real-time data using an unsupervised learning method, wherein the unsupervised learning method comprises logic using at least one of a k-means clustering, a hierarchical clustering, a hidden Markov model, and an apriori algorithm.

In some embodiments, the machine learning model has a feedback loop, wherein an output from a previous step is fed back to the machine learning model in real-time to improve the performance and accuracy of the output of a next step.

In some embodiments, the machine learning model has a feedback loop, wherein the learning is further reinforced with a reward for each true positive of the output of the system.

In some embodiments, the machine learning model comprises a recurrent neural network model.

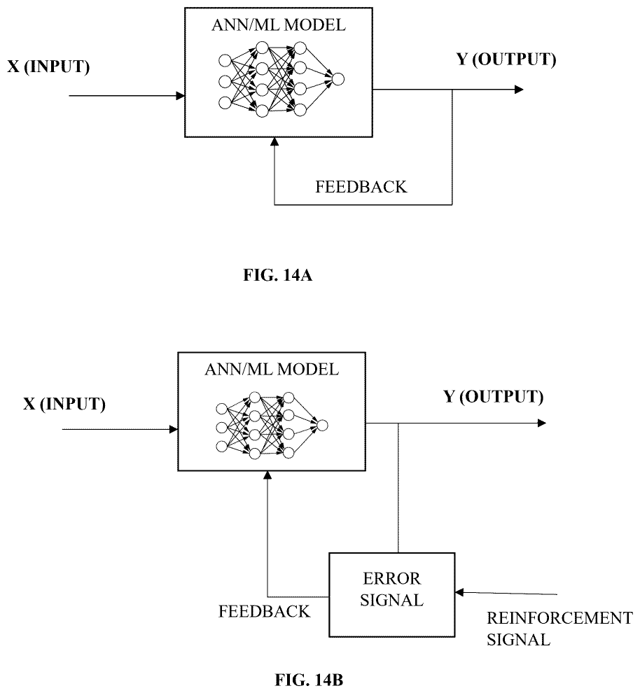

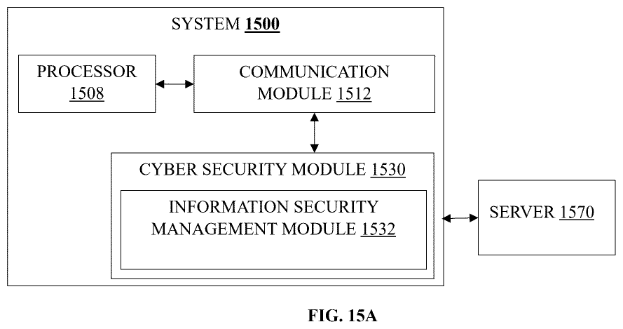

FIG. 14A shows a structure of the neural network/machine learning model with a feedback loop according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. Input data comprises data associated with malfunction information 1304, contextual data/information 1306, and input data 1308. The output layer may be predictions of an optimized corrective action, based on the inputs which may be malfunction information 1304, contextual data/information 1306, and input data 1308.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine backpropagation, propagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labeled data and concepts, after a while the models' performance may decline while adding new unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., a corrective action, etc.) are used that are meant for the model to learn how, and what, adjustments need to be performed. Afterward, the model is tested using unlabeled data. By using, for example, deep learning and neural networks, the model can then make predictions on whether the desired output (for e.g., determination of a corrective action, etc.) is in the predicted accuracy level. However, in the cases where the model returns a low probability score, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system can improve its predictions in real-time and dynamically.

FIG. 14B shows a structure of the neural network/machine learning model with reinforcement learning according to an embodiment. The network receives feedback from authorized networked environments. Though the feedback logic is similar to supervised learning, the feedback obtained in this case is evaluative, not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

FIG. 15A illustrates the block diagram of the cyber security module in view of the system and server according to an embodiment.

Referring to FIG. 15A, system 1500 comprising processor 1508, communication module 1512, cyber security module 1530, and information security management module 1532 in communication with server 1570 is shown. In an embodiment, FIG. 15A shows the block diagram of the cyber security module. The communication of data between the system 1500 and the server 1570 through the communication module 1512 is first verified by the information security management module 1532 before being transmitted from the system to the server or from the server to the system. The information security management module is operable to analyze the data for potential cyber security threats, to encrypt the data when no cyber security threat is detected, and to transmit the data encrypted to the system or the server.

FIG. 15B shows an embodiment of the cyber security module, in accordance with some embodiments of the present disclosure.

In an embodiment, the cyber security module further comprises an information security management module providing isolation between the system and the server. FIG. 15B shows the flowchart of securing the data through the cyber security module 1530. At step 1540, the information security management module is operable to receive data from the communication module. At step 1541, the information security management module exchanges a security key at a start of the communication between the communication module and the server. At step 1542, the information security management module receives a security key from the server. At step 1543, the information security management module authenticates an identity of the server by verifying the security key. At step 1544, the information security management module analyzes the security key for potential cyber security threats. At step 1545, the information security management module negotiates an encryption key between the communication module and the server. At step 1546, the information security management module receives the encrypted data. At step 1547, the information security management module transmits the encrypted data to the system when no cyber security threat is detected.

FIG. 15C shows another embodiment of the cyber security module, in accordance with some embodiments of the present disclosure.

In an embodiment, FIG. 15C shows the flowchart of securing the data through the cyber security module 1530. At step 1551, the information security management module is operable to: exchange a security key at a start of the communication between the communication module and the server. At step 1552, the information security management module 1532 receives a security key from the server. At step 1553, the information security management module authenticates an identity of the server by verifying the security key. At step 1554, the information security management module analyzes the security key for potential cyber security threats. At step 1555, the information security management module negotiates an encryption key between the communication module and the server. At step 1556, the information security management module receives encrypted data. At step 1557, the information security management module decrypts the encrypted data, and performs an integrity check of the decrypted data. At step 1558, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 15A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

1-50. (canceled)

51. A system comprising:
a sensor;
a communication module; and
a processor storing instructions in a non-transitory memory that, when executed, cause the processor to:
obtain, using the sensor, data of a primary vehicle;
identify, based on the obtained data, a malfunction of the primary vehicle;
establish communication, via the communication module, with the primary vehicle; and
transmit, an alert message to the primary vehicle, wherein, the alert message comprises a malfunction information of the malfunction; and
wherein the system is configured to be a component of a secondary vehicle.

52. The system of claim 51, wherein the data comprises at least one of a headlight display, a brake light display, a taillight display, a turn indicator display, a lane change by the primary vehicle, a door, a trunk, a tire, and visible emissions in exhaust from the primary vehicle.

53. The system of claim 51, wherein the processor is further configured to: determine location information of occurrence of the malfunction.

54. The system of claim 51, wherein the processor is further configured to: determine a time information of occurrence of the malfunction.

55. The system of claim 51, wherein the processor is further configured to: determine image information of the malfunction.

56. The system of claim 51, wherein the processor is further configured to: determine video information of the malfunction.

57. The system of claim 51, wherein the malfunction information comprises at least one of a location information of occurrence of the malfunction, a time information of occurrence of the malfunction, image information of the malfunction, video information of the malfunction, a type of the malfunction, a severity of the malfunction, and a repetition of the malfunction.

58. The system of claim 51, wherein the communication is initiated automatically by the secondary vehicle.

59. The system of claim 51, wherein the processor is further configured to: perform object recognition with the data obtained from the sensor.

60. The system of claim 51, wherein the processor is further configured to:
transmit a start signal to the primary vehicle to check for communication compatibility;
transmit the alert message based on an acknowledgement received from the primary vehicle; and
inhibit transmission of the alert message based on absence of acknowledgement received from the primary vehicle.

61. The system of claim 51, wherein the processor is further configured to:
evaluate the malfunction for an unsafe condition for the primary vehicle; and
transmit the malfunction information to at least one other vehicle proximate to the secondary vehicle.

62. The system of claim 51, wherein the system comprises a plurality of sensors.

63. The system of claim 51, wherein the sensor comprises at least one of a radar-based sensor, a LAser Detection And Ranging (LADAR) sensor, a Light Detection and Ranging (LIDAR) sensor, a camera, an infrared camera, a night vision camera, and a thermal camera, a vision-based sensor, a light-based sensor, an infrared sensor, an optical sensor, a temperature sensor, a GPS sensor, an audio sensor, and stereo vision sensor.

64. The system of claim 63, wherein the camera comprises a revolving camera configured to obtain an accurate visual information of the malfunction.

65. The system of claim 51, wherein the communication module comprises a vehicle-to-everything (V2X) telematics communication module.

66. The system of claim 51, wherein the processor is further configured to:
generate a machine learning model; and
transmit the obtained data to the machine learning model; and
wherein the machine learning model is configured to:
predict based on the obtained data, the malfunction of the primary vehicle.

67. A method comprising:
obtaining, using a sensor, data of a primary vehicle;
identifying, based on the obtained data, a malfunction of the primary vehicle;
establishing, communication via a communication module, with the primary vehicle; and
transmitting, an alert message to the primary vehicle, wherein, the alert message comprises a malfunction information of the malfunction.

68. The method of claim 67, wherein the data of the primary vehicle comprises at least one of a headlight display, a brake light display, a taillight display, a turn indicator display, a lane change by the primary vehicle, a door, a trunk, a tire, and visible emissions in exhaust from the primary vehicle.

69. The method of claim 67, further comprising:
transmitting, a start signal to the primary vehicle to check for communication compatibility;
transmitting, the alert message based on an acknowledgement received from the primary vehicle; and
inhibiting, transmission of the alert message based on absence of acknowledgement received from the primary vehicle.

70. A non-transitory computer-readable medium having stored thereon instructions executable by a computer system to perform operations comprising:
obtaining, data of a primary vehicle;
identifying, a malfunction of the primary vehicle based on the data;
establishing, communication with the primary vehicle; and
transmitting, an alert message to the primary vehicle, wherein, the alert message comprises a malfunction information of the malfunction.
